(19) United States
(12) Patent Application Publication
(10) Pub. No.: US 2020/0249835 A1
(43) Pub. Date: Aug. 6, 2020

(54) INFORMATION PROCESSING DEVICE, CONTROL DEVICE, CONTROL METHOD, AND CONTROL PROGRAM

(71) Applicant: SHARP KABUSHIKI KAISHA, Sakai City, Osaka (JP)

(72) Inventors: MASAFUMI UENO, Sakai City (JP); NAOKI SHIOBARA, Sakai City (JP)

(73) Assignee: SHARP KABUSHIKI KAISHA, Sakai City, Osaka (JP)

(21) Appl. No.: 15/774,509

(22) PCT Filed: Oct. 11, 2016
(86) PCT No.: PCT/JP2016/080097

§ 371 Date: May 8, 2018

(30) Foreign Application Priority Data
Nov. 11, 2015 (JP) 2015-221581

(51) Int. Cl. G06F 3/0488; G06F 3/0482

(52) U.S. Cl. CPC G06F 3/04886; G06F 3/0482

(57) ABSTRACT

An information processing device capable of automatically adjusting the size of a work area and the like is provided. An information processing device (1) includes a display device (10) including a screen configured to display a work area, an NFC unit (112) superimposed on the screen, a terminal information acquisition unit (211) configured to acquire terminal information about a terminal device, a positional information acquisition unit (212) configured to acquire positional information about an NFC antenna (114) used for acquiring the terminal information, and a work area setting unit (213) configured to set the work area.

### TECHNICAL FIELD

The present disclosure relates to an information processing device or the like that processes information acquired, via a display device including a communication unit that performs near field communication, from a terminal device by near field communication.

### BACKGROUND ART

In recent years, displays including a transparent antenna for near field communication (hereinafter referred to as NFC) built therein have been developed. The display includes a transparent antenna layer installed on a front surface, which enables communication by bringing a terminal device (NFC terminal such as a smart phone having NFC functionality or a card having NFC functionality) close to a display surface of the display.

As an information processing device including such a display usable by a plurality of people at the same time, a desktop information processing device including a touch panel display and a plurality of sensor units provided separately from the touch panel display is described in PTL 1, for example. In the desktop information processing device, a sensor unit reads ID card information, and the touch panel display displays a work area of an individual. A direction in which a desktop screen is to be displayed is determined by which sensor among the plurality of sensor units acquires the ID card information.

### CITATION LIST

### Patent Literature

PTL 1: JP 2013-125551 A (published on Jun. 24, 2013)

### SUMMARY OF INVENTION

### Technical Problem

However, in the desktop information processing device disclosed in PTL 1, the size of a work area to be displayed is determined in advance at the time when ID card information is read. A user needs to manually operate to adjust the size of a work area every time the user logs in, thereby requiring a lot of time and effort.

Thus, an object of the following disclosure is to provide an information processing device capable of automatically adjusting the size of a work area or the like.

### Solution to Problem

To solve the above-described problems, an information processing device according to one aspect of the present invention includes: a display device including a screen configured to display a work area; a communication unit superimposed on the screen and configured to perform near field communication; a terminal information acquisition unit configured to acquire terminal information about each of a plurality of terminal devices held over the communication unit from the terminal device via the communication unit; a positional information acquisition unit configured to acquire positional information including information about a position of an antenna used for acquiring the terminal information among a plurality of antennas provided in the communication unit; and a work area setting unit configured to set a plurality of respective work areas for the plurality of terminal devices on the screen, based on the terminal information and the positional information.

An information processing device according to one aspect of the present invention is an information processing device connected and capable of communicating with a display device including a screen configured to display a work area. The information processing device includes: a touch sensor including a detection surface corresponding to the screen and configured to detect an object that is in contact with or in close proximity to the detection surface; a communication unit superimposed on the touch sensor and including one antenna configured to perform near field communication; a terminal information acquisition unit configured to acquire terminal information about each of a plurality of terminal devices held over the communication unit from the terminal device via the communication unit; a positional information acquisition unit configured to acquire touch information including information about a position of each of the plurality of terminal devices that is in contact with or in close proximity to the touch sensor; and a work area setting unit configured to set a plurality of respective work areas for the plurality of terminal devices on the screen, based on the touch information and the terminal information.

A control device according to one aspect of the present invention is a control device of an information processing device that includes a display device including a screen configured to display a work area, and a communication unit superimposed on the screen and configured to perform near field communication. The control device includes: a terminal information acquisition unit configured to acquire terminal information about each of a plurality of terminal devices held over the communication unit from the terminal device via the communication unit; a positional information acquisition unit configured to acquire positional information including information about a position of an antenna used for acquiring the terminal information among a plurality of antennas provided in the communication unit; and a work area setting unit configured to set a plurality of respective work areas for the plurality of terminal devices on the screen, based on the terminal information and the positional information.

A control method according to one aspect of the present invention is a control method for controlling an information processing device that includes a display device including a screen configured to display a work area, and a communication unit superimposed on the screen and configured to perform near field communication. The control method includes: a terminal information acquisition step of acquiring terminal information about each of a plurality of terminal devices held over the communication unit from the terminal device via the communication unit; a positional information acquisition step of acquiring positional information including information about a position of an antenna used for acquiring the terminal information among a plurality of antennas provided in the communication unit; and a work area setting step of setting a plurality of respective work areas for the plurality of terminal devices on the screen, based on the terminal information and the positional information.

### Advantageous Effects of Invention

The information processing device according to one aspect of the present invention includes an advantageous effect that the size of a work area or the like can be automatically adjusted.

The control device and the control method according to one aspect of the present invention include an advantageous effect that an information processing device including a touch sensor and a communication unit is controlled such that the size of a work area or the like on the touch sensor can be automatically adjusted.

### BRIEF DESCRIPTION OF DRAWINGS

FIG. 1 is a block diagram illustrating an example of a primary configuration of an information processing device according to a first embodiment of the present invention.

FIG. 2 is a diagram illustrating a specific configuration of an NFC display provided in the information processing device illustrated in FIG. 1.

FIGS. 3A and 3B are diagrams for describing the principles of a touch sensor provided in the information processing device illustrated in FIG. 1, and FIGS. 3C and 3D are diagrams illustrating an example of a sensor signal generated in a case where an object comes into contact with the touch sensor.

FIG. 4 is a plan view illustrating area sections of the NFC display provided in the information processing device illustrated in FIG. 1.

FIGS. 5A to 5I are diagrams for describing a layout of a work area(s) set on the NFC display.

FIGS. 6A to 6F are diagrams for describing a layout of work areas set again on the NFC display.

FIG. 7 is a diagram illustrating an example of another shape of the work area.

FIGS. 8A and 8B illustrate an example of an NFC terminal in which a direction held over an NFC antenna can be recognized.

FIG. 9 is a block diagram illustrating an example of a primary configuration of an information processing device according to a second embodiment of the present invention.

FIG. 10A illustrates an example of each parameter of a terminal candidate area identified by shape analysis, and FIG. 10B illustrates a specific example of touch information in a case where an object is a rectangular NFC terminal.

FIG. 11A illustrates an example of each parameter of a terminal candidate area identified by shape analysis, and FIG. 11B illustrates a specific example of touch information in a case where an object is an elliptic NFC terminal.

FIG. 12 is a flowchart illustrating an example of a processing flow executed by the information processing device in the second embodiment.

FIG. 13 is a flowchart illustrating an example of a flow of an association process included in the flowchart of FIG. 12.

FIGS. 14A to 14C are diagrams for describing a layout of a work area in a case where a first employee logs in to the information processing device.

FIGS. 15A to 15C are diagrams for describing a layout of a work area(s) in a case where a second employee logs in to the information processing device.

FIGS. 16A to 16C are diagrams for describing a layout of the work areas in a case where a third employee logs in to the information processing device.

FIG. 17 is a block diagram illustrating an example of a primary configuration of an information processing device in a third embodiment of the present invention.

FIG. 18A is a diagram for describing a point which can be improved in the information processing device in the first embodiment, and FIGS. 18B and 18C are diagrams for describing a point which can be improved in the information processing device in the second embodiment.

FIGS. 19A and 19B are diagrams for describing an example in a case where employees use the information processing device in the third embodiment of the present invention.

FIGS. 20A to 20F are diagrams for describing an example in a case where employees use an information processing device in a fourth embodiment of the present invention.

FIGS. 21A to 21D are diagrams for describing an example in a case where employees use an information processing device in a fifth embodiment of the present invention.

FIGS. 22A and 22B are diagrams for describing an example in a case where employees use an information processing device as a modification of the present invention.

FIG. 23 is a diagram illustrating a schematic configuration of an information processing device according to a sixth embodiment of the present invention.

### DESCRIPTION OF EMBODIMENTS

### First Embodiment

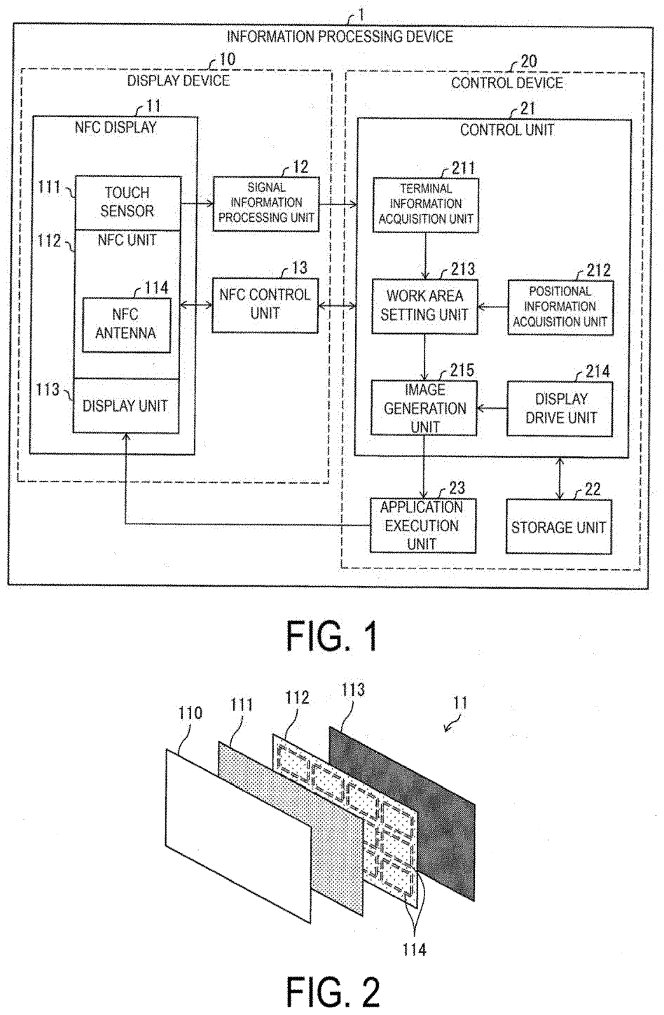

Hereinafter, an embodiment of the present invention will be described with reference to FIG. 1 to FIG. 8B.

### Information Processing Device 1

First, a primary configuration of an information processing device 1 according to the present embodiment will be described with reference to FIG. 1. FIG. 1 is a block diagram illustrating an example of the primary configuration of the information processing device 1. The information processing device 1 includes, as one unit, a display device 10 configured to display images, and a control device 20 configured to control the display device 10. The information processing device 1 further includes an NFC display 11, a signal information processing unit 12, an NFC control unit 13, a control unit 21, a storage unit 22, and a display drive unit 23.

Note that, in the information processing device 1, the display device 10 and the control device 20 may be separate units. In such a configuration, the display device 10 and the control device 20 may transmit and/or receive information via a communication unit (not illustrated). Note that the transmission and reception of information may be performed in a wired or wireless fashion. Furthermore, the display device 10 and the control device 20 may transmit and/or receive information via another device such as a router.

### Display Device 10

The NFC display 11 is a display capable of near field communication with an NFC terminal (terminal device). The NFC display 11 include a touch sensor 111, an NFC unit 112 (antenna layer), and a display unit 113 (screen). Note that NFC includes all types of short-range radio communication, and include, for example, near field communication that uses Radio Frequency IDentification (RFID) technology such as a non-contact Integrated Circuit (IC) card or a non-contact IC tag, The NFC display 11 can recognize multi-touch such as 10 point multi-touch and allows operation on each work area independently of another work area in a plurality of work areas described below.

A specific configuration of the NEC display 11 will be described with reference to FIG. 2. FIG. 2 is a diagram illustrating the specific configuration of the NFC display 11. As illustrated in FIG. 2, the NFC display 11 includes a protective glass 110, the touch sensor 111, the NFC unit 112, and the display unit 113 which are stacked in that order from the outermost portion. Note that a member in which the touch sensor and the display unit are stacked is referred to as a “touch panel” herein.

The touch sensor 111 is a sensor configured to detect contact of an object. The touch sensor 111 has a detection surface associated with the display unit 113 described below and detects contact of an object with the detection surface.

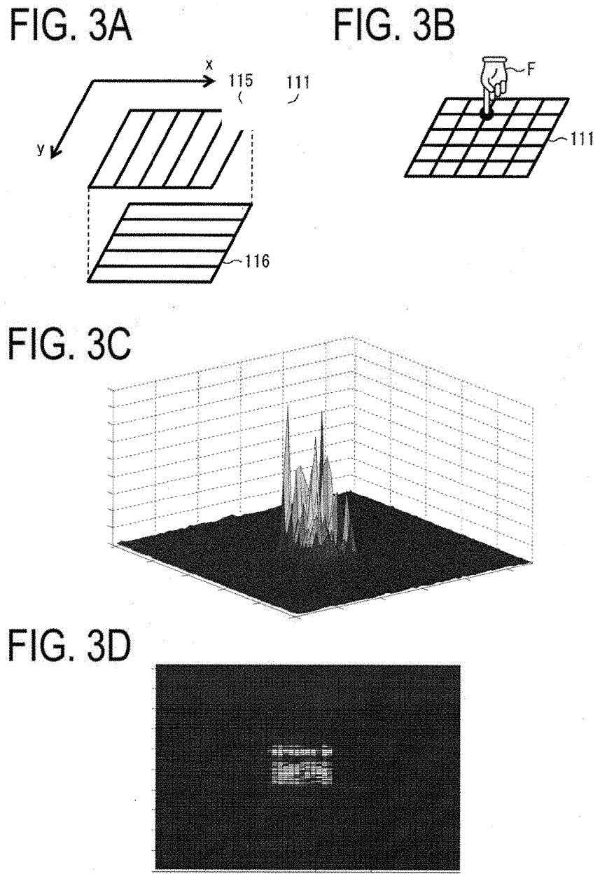

Here, details of the touch sensor 111 being a capacitive sensor will be described with reference to FIGS. 3A to 3D, FIGS. 3A and 3B are diagrams for describing the principles of the touch sensor 111. FIGS. 3C and 3D are diagrams illustrating an example of a sensor signal generated in a case where an object comes into contact with the touch sensor 111.

As illustrated in FIG. 3A, the touch sensor 111 is formed of a transparent electrode 115 extending in a Y direction and a transparent electrode 116 extending in an X direction which are layered vertically. Next, as illustrated in FIG. 3B, capacitance changes in a case where an object having conductivity (finger F in FIG. 3B) comes into contact with the touch sensor 111. At this time, detecting a change in capacitance between which pair of the electrodes makes it possible to identify the coordinates with which the object comes into contact.

FIGS. 3C and 3D are diagrams illustrating an example of a sensor signal indicating the amount of change in the capacitance in a case where an object such as a card having NFC functionality is brought into contact with the touch sensor 111. Note that the card having NFC functionality includes an antenna coil for enabling NFC functionality, and the conductivity of the antenna coil enables the touch sensor 111 to detect contact of the card.

In a case where the card is brought into contact with the touch sensor 111, a sensor signal as illustrated in FIG. 3C is generated. When illustrated as a top view, as illustrated in FIG. 3D, it can be seen that the sensor signal is generated in the shape of the contact surface of the card (the surface in contact with the touch sensor 111). Specifically, a sensor signal having a shape corresponding to the shape of the antenna coil is generated. Note that, in a case where the NFC terminal itself has conductivity, a sensor signal having a shape corresponding to the shape of the NFC terminal is generated. The touch sensor 111 outputs signal information indicating the sensor signal to the signal information processing unit 12. Specifically, the touch sensor 111 outputs the signal information to the signal information processing unit 12 at a frequency of from 60 to 240 times per second.

Note that, although not illustrated, in a case where a pointer such as a finger comes into contact with the touch sensor 111, a wide-range sensor signal (in other words, a broad sensor signal) like that of FIG. 3C is not generated, but a narrow-range sensor signal (in other words, a narrow sensor signal) is generated.

Note that in the present embodiment, a capacitive touch sensor is used as the touch sensor 111, but an infrared sensor (optical sensor) or a pressure-sensitive sensor may be used as the touch sensor 111. The touch sensor 111 may use, as the signal information, information about a change in capacitance generated in a case where an object is in not direct contact with, but in close proximity to the touch sensor 111, that is to say, by a hover touch of the object. In this way, the touch sensor according to one aspect of the present invention is only necessary to be capable of detecting an object that is in contact with or in close proximity to the touch sensor.

The NFC unit 112 serves as a communication device configured to perform near field communication with external devices. The NFC unit 112 serves as an antenna module (multi-antenna) including a plurality of NFC antennas 114 (antennas). The NFC antennas 114 are transparent antennas serving as a tag reader capable of detecting NFC tags, and transmitting and/or receiving information. Specifically, as illustrated in 2, the NFC unit 112 is a sheet-shaped member provided in between the touch sensor 111 and the display unit 113.

In FIG. 2, three NFC antennas 114 in a vertical direction (short-side direction of the NFC unit 112) and four NFC antennas 114 in a horizontal direction (long-side direction of the NFC unit 112) are disposed in the entire NFC unit 112. However, the number and the layout of the NFC antennas 114 are not limited to the example illustrated in FIG. 2. For example, four NFC antennas 114 in the vertical direction and five NFC antennas 114 in the horizontal direction may be disposed as described below. Alternatively, the NFC antennas 114 may be provided in only four corners of the NFC unit 112, or the NFC antennas 114 may be provided at only end portions of the NFC unit 112.

A position of the NFC unit 112 is not limited to a position between the touch sensor 111 and the display unit 113 illustrated in FIG. 2. The NFC antennas 114 may be provided in the touch sensor 111. In other words, the touch sensor 111 and the NFC unit 112 may be integrated as one unit.

The plurality of NFC antennas 114 are each assigned in advance with a unique antenna ID for identifying each of the NFC antennas 114. The NFC unit 112 can partially drive the plurality of NFC antennas 114 according to an activated application (hereinafter also referred to as an “app”). The NFC unit 112 can also arbitrarily select and drive the NFC antenna 114 in a position convenient to a user or in accordance with a screen display (layout) of an app. This is one of the advantages of providing the multi-antenna in the NFC unit 112.

The display unit 113 serves as a display device having an image display function of displaying, as an image in a display area, information to be processed by the information processing device 1. The display unit 113 is a liquid crystal display (LCD), for example, but is not limited to this example. The display unit 113 may include a backlight.

The signal information processing unit 12 (Touch Panel (TP) controller) analyzes a touch signal input to the touch sensor 111 and transmits touch information to the control unit 21 described below. The touch information will be described in detail in a second embodiment. Here, whether an object contacting the touch sensor 111 is an NFC terminal or a pointer such as a finger is not analyzed in the present embodiment.

The NFC control unit 13 (communication control unit, NFC controller) controls drive of the NFC antennas 114, based on a control signal from the control unit 21. The NFC control unit 13 transmits, to the control unit 21, NFC information being a combination of terminal information acquired from an NFC terminal and an antenna ID of the NFC antenna 114 used for the communication to acquire the terminal information.

### Control Device 20

### Control Unit 21

The control unit 21 collectively controls the functions of each unit of the information processing device 1, particularly the functions of the control device 20. The control unit 21 controls the display unit 113, and activates and controls an app according to a touch operation of a user to the NFC display 11. The control unit 21 includes a terminal information acquisition unit 211, a positional information acquisition unit 212, a work area setting unit 213, an application execution unit 214, and an image generation unit 215.

The terminal information acquisition unit 211 acquires terminal information about an NFC terminal via the NFC unit 112. Examples of the NEC terminal include a card including antennas for NFC built therein. The terminal information is, for example, an NFC terminal ID that identifies an NFC terminal, terminal data being unique information held by an NFC terminal, and the like. The terminal information acquisition unit 211 transmits a control signal for acquiring terminal information to the NFC control unit 13.

The positional information acquisition unit 212 acquires positional information including information about a position of the NFC antenna 114 used for acquiring the terminal information, based on an antenna ID included in the NFC information. Specifically, the positional information acquisition unit 212 compares the antenna ID of the NFC antenna 114 used for the communication to acquire the terminal information with antenna position information stored in the storage unit 22 described below. The antenna position information is information indicating an association between the antenna ID of the NFC antenna 114 and a position of the NFC antenna 114 having the antenna ID.

In a case where the NFC antenna 114 is a rectangle, for example, information about a position of the NFC antenna 114 (information indicating a position of the NFC antenna 114) may be XY plane coordinates of an upper left vertex and a lower right vertex of the NFC antenna 114 in an XY plane coordinate system defined on the NFC unit 112 with an upper left vertex of the NFC unit 112 as the origin. Alternatively, information about a position of the NFC antenna 114 may be XY plane coordinates of a center point of the NFC antenna 114 in the XY plane coordinate system. However, the information about a position of the NFC antenna 114 is not limited to these examples.

The work area setting unit 213 sets a plurality of respective work areas for a plurality of NFC terminals on the NFC display 11, i.e., on the display unit 113, based on the positional information and the terminal information. The work area is an area allowing data possessed by an individual to be viewed or edited. Settings of the work area made by the work area setting unit 213 will be described below. The work area setting unit 213 may instruct the NFC unit 112 via the NFC control unit 13 to stop driving the NFC antenna 114 superimposed on the work area.

The application execution unit 214 executes various apps included in the information processing device 1. Specifically, when a user logs in to the information processing device 1, the application execution unit 214 executes an app associated with the user who logs in among apps stored in the storage unit 22 in a work area set for the user. Next, the application execution unit 214 instructs the image generation unit 215 to generate an image. The application execution unit 214 transmits, to the NFC control unit 13, a control signal for controlling drive of the NFC antenna 114 associated with the app and a signal for the NFC terminal from the app.

The application execution unit 214 controls the app, based on touch information acquired from the signal information processing unit 12. At this time, an operation instruction is reflected for each work area, based on positional information in the work area so as to control the app for each work area, based on the touch information. Examples of the app executed by the application execution unit 214 include an app allowing access to personal data in an in-house server, a cloud, or a private PC.

The application execution unit 214 may execute, as a shared app, an app causing the NFC display 11 to display a guide indicating a position of the NFC antenna 114 and/or a message prompting a user to hold an NFC terminal over the NFC antenna 114.

The image generation unit 215 generates an image in accordance with instructions from the work area setting unit 213 and the application execution unit 214. The image generation unit 215 outputs the generated image to the display drive unit 23.

Note that the display drive unit 23 is a member configured to control the display unit 113. Specifically, the display drive unit 23 causes the display unit 113 to display the image acquired from the image generation unit 215.

The control unit 21 includes an authentication unit (not illustrated) configured to perform personal authentication based on the NFC terminal ID included in the terminal information. The application execution unit 214 accesses data of an individual authenticated by the authentication unit in a case of executing an app that accesses the personal data.

### Storage Unit 22

The storage unit 22 stores various types of data used by the information processing device 1. The storage unit 22 stores at least an app, antenna position information, and a work area pattern. The work area pattern is a pattern of a shape and a size of a work area, which is set when an NFC terminal is held over the NFC antenna 114, corresponding to terminal information and positional information about the NFC terminal. The app and the antenna position information have been described above and are thus not described here.

Log-in authentication data for an NFC terminal, information about settings of individuals and data of the individuals may be stored in the storage unit 22 or kept in an external storage device (not illustrated) connected to the information processing device 1 through a network. Examples of the external storage device include a cloud, an in-house server, and a private PC.

### Outline of Processing of Information Processing Device 1

Examples of a method for using the information processing device 1 include transmission and reception of data, personal authentication, and payment by credit card through communication with an NFC terminal, such as an NFC-equipped mobile terminal, an NFC card, or an NFC tag, held over the NFC antenna 114. Because the NFC antenna 114 is superimposed on the display unit 113, a guide indicating a position of the NFC antenna 114 can be displayed on the display unit 113. This allows a user to intuitively operate the NFC display 11.

Hereinafter, an outline of processing (actions) of the information processing device 1 will be described in which an NFC card for personal authentication is used as an NFC terminal. The card for personal authentication is, for example, an employee card of a company, a membership card for a facility user, or the like. The NFC terminal may be a mobile terminal such as a smart phone in which the same information as that of the cards is stored.

Hereinafter, a usage example of the information processing device 1 as a shared PC terminal usable by a plurality of employees will be described. The information processing device 1 is configured to perform personal authentication (log-in) with an NFC card of an employee held over the information processing device 1. Specifically, the terminal information acquisition unit 211 acquires terminal information from the NFC card (terminal information acquisition step) and determines whether an NFC terminal ID included in the terminal information is the NFC terminal ID of the employee permitted to use the information processing device 1.

In a case where it is authenticated (determined) that the employee is permitted to use the information processing device 1, the positional information acquisition unit 212 acquires an ID of the NFC antenna 114 acquired from the NFC control unit 13 and positional information of the NFC antenna 114 used for the communication to acquire the terminal information, from antenna position information stored in the storage unit 22 (positional information acquisition step).

The work area setting unit 213 sets a work area of the employee on the NFC display 11, based on any of the positional information, work area information included in the terminal information, and a setting pattern of the work area stored in the storage unit 22 (work area setting step). The work area setting unit 213 also causes the display unit 113 to display the work area, thereby improving operability of the information processing device 1 by the employee. Particularly in the information processing device 1, the work area can be displayed on the display unit 113 superimposed over the touch sensor 111, thereby further improving operability of the information processing device 1 by the employee.

At this time, a method for controlling the information processing device 1 can be expressed as follows. Specifically, the method for controlling the information processing device 1 to set a work area includes a terminal information acquisition step of acquiring terminal information included in each of a plurality of NFC cards held over the NFC unit 112 from the terminal device via the NFC unit 112, a positional information acquisition step of acquiring positional information including information about a position of the NFC antenna 114 used for acquiring the terminal information among the plurality of NFC antennas 114 provided in the NFC unit 112, and a work area setting step of setting a plurality of respective work areas for a plurality of the terminal devices on the display unit 113, based on the terminal information and the positional information.

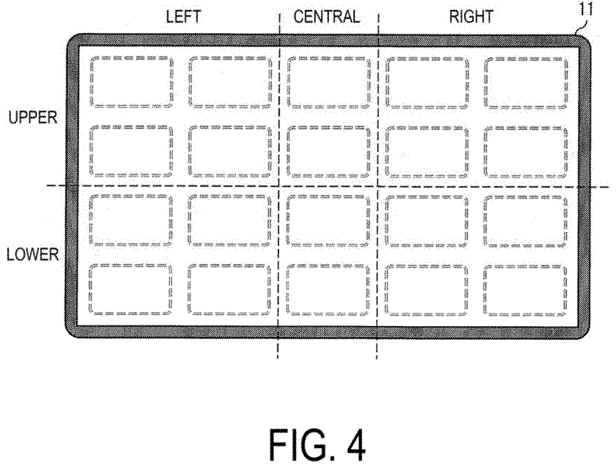

The setting pattern of the work area defines a position and a size of the work area according to the positional information and a use state of the information processing device 1 by another employee. The work area information includes information about whether a shape of a work area is a vertical type or a horizontal type, customized for each employee. Herein, the “vertical type” means a shape having a length in an up-and-down direction longer than a length in a left-and-right direction, and the “horizontal type” means a shape having a length in the up-and-down direction shorter than a length in the left-and-right direction. See FIG. 4 described below for the “up-and-down direction” and the “left-and-right direction”.

Furthermore, the work area information may include a size or an aspect ratio of a work area, or the like. The work area information may be associated with the NFC terminal ID of the employee permitted to use the information processing device 1 and stored in the storage unit 22.

The application execution unit 214 executes an app in the work area. Examples of the app include an app causing a preset private PC screen to be displayed in the work area.

Note that, as described below, a layout of a window of an app (work screen of an app) may be defined in advance for each type of apps executed by the application execution unit 214. For example, in a case where an app is software for presentations, a horizontally long window may be displayed in a work area. In a case where an app is software for word processing, a vertically long window may be displayed in a work area. The size of a window may be defined in advance for each type of apps executed by the application execution unit 214.

The private PC screen may be a screen displaying personal data in an in-house server or a cloud, or may be a screen of a private PC displayed by remote access, the private PC being connected to an in-house LAN. As described above, the touch sensor 111 and the display unit 113 are superimposed on each other to form the touch panel in the NFC display 11 provided in the information processing device 1. This enables a touch operation on a private PC screen displayed on the NFC display 11.

In a case where only one employee uses the information processing device 1, it is preferable that an area other than the work area in use can be logged in by a different employee. Specifically, for example, the work area setting unit 213 may control the NFC control unit 13 such that the NFC control unit 13 stops driving the NFC antenna 114 superimposed on the work area and drives only the NFC antennas 114 that are not superimposed on the work area. For example, the application execution unit 214 may execute an app causing an area other than the work area in use to display a message prompting a different employee to log in.

### Specific Example of Work Area Settings When Employee Logs in

Hereinafter, a specific example of work area settings in a case where a plurality of employees successively log in to the information processing device 1 will be described. In other words, a specific example of a setting pattern of a work area by the work area setting unit 213 will be described. However, a method for setting a work area is not limited to the following specific examples.

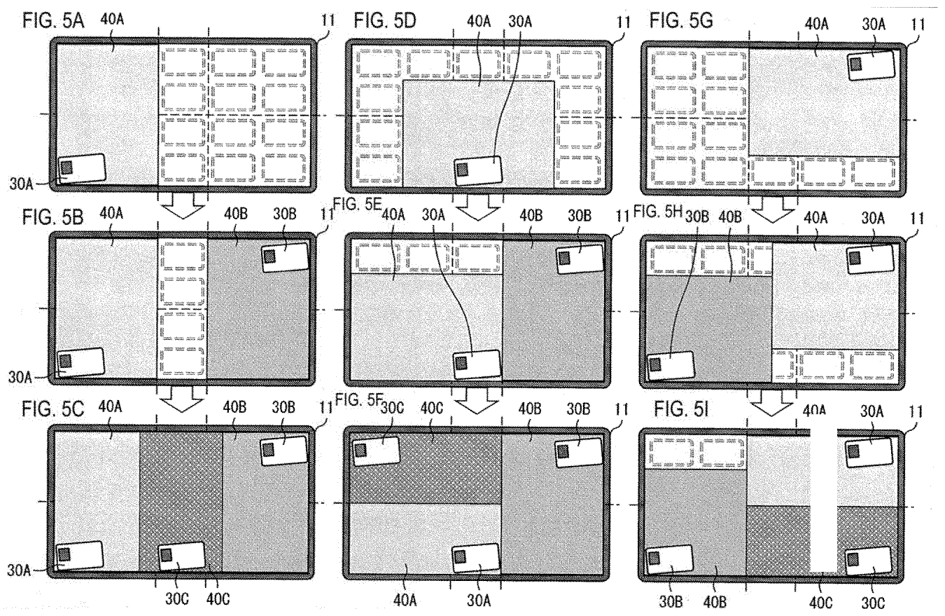

FIG. 4 is a plan view illustrating area sections of the NFC display 11. The NFC display 11 illustrated in FIG. 4 includes four NFC antennas 114 disposed in the vertical direction and five NFC antennas 114 disposed in the horizontal direction. In the following specific examples, as illustrated in FIG. 4, the NFC display 11 is divided into six areas, which are upper left, lower left, upper central, lower central, upper right, and lower right areas. FIGS. 5A to 5I are diagrams for describing a layout of a work area(s) set on the NFC display 11.

Description of personal authentication is omitted in the following specific examples. The alphabet of A to C attached after an “employee” is a symbol for identifying a plurality of “employees”. An employee card and a work area of an employee A are respectively an employee card 30A and a work area 40A. Similarly, an employee card and a work area of an employee B are respectively an employee card 30B and a work area 40B. An employee card and a work area of an employee C are respectively an employee card 30C and a work area 40C.

### First Specific Example at the Time of Log-In

First, a first specific example at the time of log-in is described with reference to FIGS. 5A to 5C. A state is first assumed in which no one logs in to the information processing device 1. It is then assumed that the employee A who previously sets work area information as the vertical type holds his/her employee card 30A over the NFC antenna 114 located in the lower left area of the NFC display 11 to log in to the information processing device 1.

In this case, the work area setting unit 213 reads, from the storage unit 22, a work area setting pattern (first pattern) corresponding to “a case where an employee card having positional information as a lower left area is present” and “a case where work area information about the employee card held over the lower left area is the vertical type”.

Then, as illustrated in FIG. 5A, the work area setting unit 213 sets the entire upper left and lower left areas of the NFC display 11 as the work area 40A of the employee A according to the first pattern. At this time, the upper central, lower central, upper right, and lower right areas remain in a state that enables NFC, that is, the areas remain in a state allowing another employee to log in to the information processing device 1.

Next, it is assumed that the employee B who previously sets work area information as the vertical type holds his/her employee card 30B over the NFC antenna 114 located in the upper right area of the NFC display 11 to log in to the information processing device 1 in a state in which the employee A has already logged in to the information processing device 1.

In this case, the work area setting unit 213 reads, from the storage unit 22, a work area setting pattern (second pattern) corresponding to “a case where an employee card having positional information as a lower left area and an employee card having positional information as an upper right area are present”, “a case where work area information about the employee card having the positional information as the lower left area is the vertical type”, and “a case where work area information about the employee card having the positional information as the upper right area is the vertical type”.

Then, as illustrated in FIG. 5B, the work area setting unit 213 sets the entire upper right and lower right areas of the NFC display 11 as the work area 40B of the employee B according to the second pattern. At this time, the upper central and lower central areas on the NFC display 11 remain in a state allowing another employee to log in to the information processing device 1.

Next, it is assumed that the employee C holds his/her employee card 30C over the NFC antenna 114 located in the lower central area of the NFC display 11 to log in to the information processing device 1 in a state in which the employees A and B have already logged in to the information processing device 1. In this case, the work area setting unit 213 reads, from the storage unit 22, a work area setting pattern (third pattern) corresponding to “a case where an employee card having positional information as a lower left area, an employee card having positional information as an upper right area, and an employee card having positional information as a lower central area are present”, “a case where work area information about the employee card having the positional information as the lower left area is the vertical type”, and “a case where work area information about the employee card having the positional information as the upper right area is the vertical type”.

Then, as illustrated in FIG. 5C, the work area setting unit 213 reduces widths of the work areas 40A and 40B in the left-and-right direction according to the third pattern such that the work areas 40A and 40B each occupy one third of the NFC display 11. Subsequently, the central area of the NFC display 11 is set as the work area 40C of the employee C. In other words, the area on the NFC display 11 is divided into three in the left-and-right direction, and the three areas are set as the respective work areas 40A to 40C of the employees A to C. At this time, the third pattern is defined such that viewability for the employee C is prioritized and the work area 40C is the vertical type regardless of whether the work area information about the employee C is vertical or horizontal.

### Second Specific Example at the Time of Log-In

Next, a second specific example at the time of log-in is described with reference to FIGS. 5D to 5F. A state is first assumed in which no one logs in to the information processing device 1. It is then assumed that the employee A who previously sets work area information as the horizontal type holds his/her employee card 30A over the NFC antenna 114 located in the lower central area of the NFC display 11 to log in to the information processing device 1. In this case, the work area setting unit 213 reads, from the storage unit 22, a work area setting pattern (fourth pattern) corresponding to “a case where an employee card having positional information as a lower central area is present” and “a case where work area information about the employee card having the positional information as the lower central area is the horizontal type”.

Then, as illustrated in FIG. 5D, the work area setting unit 213 sets the lower central area and a part of the other areas of the NFC display 11 as the work area 40A of the employee A according to the fourth pattern. At this time, an area on the NFC display 11 that is not set as the work area 40A remains in a state allowing another employee to log in to the information processing device 1.

Next, it is assumed that the employee B who previously sets work area information as the vertical type holds his/her employee card 30B over the NFC antenna 114 located in the upper right area of the NFC display 11 to log in to the information processing device 1 in a state in which the employee A has already logged in to the information processing device 1. In this case, the work area setting unit 213 reads, from the storage unit 22, a work area setting pattern (fifth pattern) corresponding to “a case where an employee card having positional information as a lower central area and an employee card having positional information as an upper right area are present”, “a case where work area information about the employee card having the positional information as the lower central area is the horizontal type”, and “a case where work area information about the employee card having the positional information as the upper right area is the vertical type”.

Then, as illustrated in FIG. 5E, the work area setting unit 213 moves the work area 40A to the left and sets the upper right area and the lower right area of the NFC display 11 as the work area 40B of the employee B according to the fifth pattern.

Next, it is assumed that the employee C holds his/her employee card 30C over the NFC antenna 114 located in the lower central area of the NFC display 11 to log in to the information processing device 1 in a state in which the employees A and B have already logged in to the information processing device 1. In this case, the work area setting unit 213 reads, from the storage unit 22, a work area setting pattern (sixth pattern) corresponding to “a case where an employee card having positional information as a lower central area, an employee card having positional information as an upper right area, and an employee card having positional information as an upper left area are present”, “a case where work area information about the employee card having the positional information as the lower central area is the horizontal type”, and “a case where work area information about the employee card having the positional information as the upper right area is the vertical type”.

Then, as illustrated in FIG. 5F, the work area setting unit 213 reduces a length in the up-and-down direction of the work area 40A to half a length in the up-and-down direction of the NFC display 11 and sets the area above the work area of the employee A as the work area 40C of the employee C according to the sixth pattern. At this time, the sixth pattern is defined such that viewability for the employee C is prioritized and the work area 40C is the horizontal type regardless of whether the work area information about the employee C is vertical or horizontal.

### Third Specific Example at the Time of Log-In

Next, a third specific example at the time of log-in is described with reference to FIGS. 5G to 5I. A state is first assumed in which no one logs in to the information processing device 1. It is then assumed that the employee A who previously sets work area information as the horizontal type holds his/her employee card 30A over the NFC antenna 114 located in the upper right area of the NFC display 11 to log in to the information processing device 1. In this case, the work area setting unit 213 reads, from the storage unit 22, a work area setting pattern (seventh pattern) corresponding to “a case where an employee card having positional information as an upper right area is present” and “a case where work area information about the employee card having the positional information as the upper right area is the horizontal type”.

Then, as illustrated in FIG. 5G, the work area setting unit 213 sets the upper right area, the upper central area, a part of the lower right area, and a part of the lower central area of the NFC display 11 as the work area 40A of the employee A according to the seventh pattern. At this time, an area on the NFC display 11 that is not set as the work area 40A remains in a state allowing another employee to log in to the information processing device 1.

Next, it is assumed that the employee B who sets work area information as the horizontal type holds his/her employee card 30B over the NFC antenna 114 located in the lower left area of the NFC display 11 to log in to the information processing device 1 in a state in which the employee A has already logged in to the information processing device 1. In this case, the work area setting unit 213 reads, from the storage unit 22, a work area setting pattern (eighth pattern) corresponding to “a case where an employee card having positional information as an upper right area and an employee card having positional information as a lower left area are present”, “a case where work area information about the employee card having the positional information as the upper right area is the horizontal type”, and “a case where work area information about the employee card having the positional information as the lower left area is the horizontal type”.

Then, as illustrated in FIG. 5H, the work area setting unit 213 reduces a length in the left-and-right direction of the work area 40A to half a length in the left-and-right direction of the NFC display 11 and sets the lower left area, a part of the lower central area, and the lower right area of the NFC display 11 as the work area 40B of the employee B according to the eighth pattern.

Next, it is assumed that the employee C holds his/her employee card 30C over the NFC antenna 114 located in the lower right area of the NFC display 11 to log in to the information processing device 1 in a state in which the employees A and B have already logged in to the information processing device 1. In this case, the work area setting unit 213 reads, from the storage unit 22, a work area setting pattern (ninth pattern) corresponding to “a case where an employee card having positional information as an upper right area, an employee card having positional information as a lower left area, and an employee card having positional information as a lower right area are present”, “a case where work area information about the employee card having the positional information as the upper right area is the horizontal type”, and “a case where work area information about the employee card having the positional information as the lower left area is the horizontal type”.

Then, as illustrated in FIG. 5I, the work area setting unit 213 reduces a length in the up-and-down direction of the work area 40A to half a length in the up-and-down direction of the NFC display 11 and sets the area above the work area 40A as the work area 40C of the employee C according to the ninth pattern. At this time, the ninth pattern is defined such that viewability for the employee C is prioritized and the work area 40C is the horizontal type regardless of whether the work area information about the employee C is vertical or horizontal.

A part of the upper left area of the NFC display 11 is not included in any of the work areas 40A to 40C. Thus, the area is in a state where the NFC antennas 114 are driven and also a different employee can log in.

### Specific Example of Work Area Setting When Employee Logs Out

In a case where some employees log out of the information processing device 1 in a state in which a plurality of work areas are set, the work area setting unit 213 may delete the work areas of the employees. At this time, in a case where work areas of other plurality of employees logging in to the information processing device 1 remain present, the work area setting unit 213 may set again the work areas of the plurality of employees.

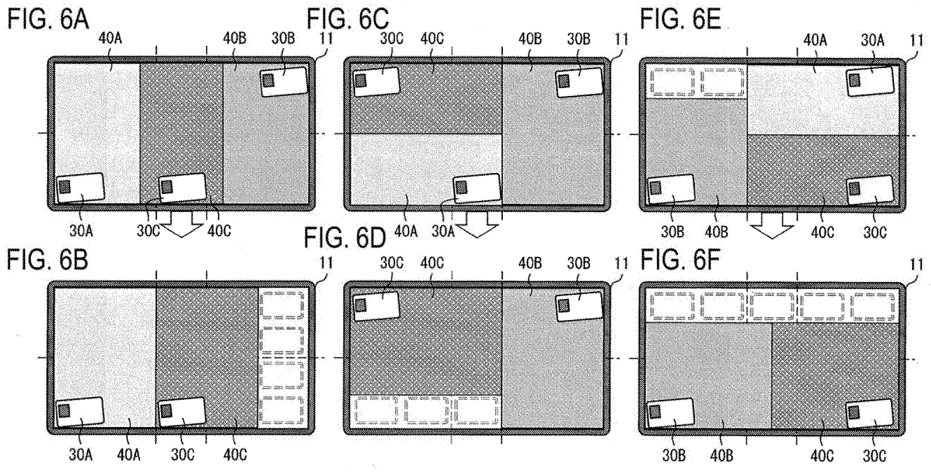

FIGS. 6A to 6F are diagrams for describing a layout of a work area set again on the NFC display 11. Hereinafter, resetting of a work area in a case where one user logs out from a state where the employees A to C log in will be described with reference to FIGS. 6A to 6F.

Note that in a case where the employees log out in reverse order to the log-in order in the specific examples described with reference to FIGS. 5A to 5I, the work area setting unit 213 may set again the work areas in the reverse order to the specific examples. For example, it is assumed that the employee C who logs in most recently among the employees A to C logs out of the information processing device 1 prior to the employees A and B in a state in which the work areas 40A to 40C of the respective employees A to C logging in to the information processing device 1 are set as illustrated in FIG. 5C. In this case, the work area setting unit 213 may delete the work area 40C and set again the work areas 40A and 40B as illustrated in 5B.

### First Specific Example at the Time of Log-Out

First, a first specific example at the time of log-out is described with reference to FIGS. 6A and 6B. As illustrated in FIG. 6A, it is first assumed that the work areas 40A to 40C of the respective employees A to C logging in to the information processing device 1 are already set on the NFC display 11. In the following description, it is assumed that the employees A, B, and C have logged in to the information processing device 1 in this order. It is assumed here that the employee B logs out of the information processing device 1 prior to the employees A and C and the work area 40B is deleted.

In this case, the work area setting unit 213 reads, from the storage unit 22, a work area setting pattern (tenth pattern) corresponding to “a case where an employee card having positional information as a lower left area and an employee card having positional information as a lower central area are present”, “a case where work area information about the employee card having the positional information as the lower left area is the vertical type”, and “a case where work area information about the employee card having the positional information as the lower central area is the vertical type”. Note that the work area information is not acquired again from the employee cards at this time, and a shape of the work areas at that point in time when the work area 40B is deleted is used as work area information.

Then, as illustrated in FIG. 6B, the work area setting unit 213 increases lengths in the left-and-right direction of the work areas 40A and 40C and also moves the work area 40C to the right according to the tenth pattern.

At this time, an area superimposed on the NFC antennas 114 located at a right end of the NFC display 11 is not made to be superimposed on the work areas, and the work areas 40A and 40C are displayed in the other area. Therefore, the NFC antennas 114 at the right end of the NFC display 11, which are not superimposed on the work areas 40A and 40C, are driven, thereby enabling the NFC antennas 114 to be used for communication by NFC.

### Second Specific Example at the Time of Log-Out

Next, a second specific example at the time of log-out is described with reference to FIGS. 6C and 6D. As illustrated in FIG. 6C, it is first assumed that the work areas 40A to 40C of the respective employees A to C logging in to the information processing device 1 are already set on the NFC display 11. It is assumed here that the employee A logs out of the information processing device 1 prior to the employees B and C and the work area 40A is deleted.

In this case, the work area setting unit 213 reads, from the storage unit 22, a work area setting pattern (eleventh pattern) corresponding to “a case where an employee card having positional information as an upper right area and an employee card having positional information as an upper left area are present”, “a case where work area information about the employee card having the positional information as the upper right area is the horizontal type”, and “a case where work area information about the employee card having the positional information as the upper left area is the horizontal type”.

Then, as illustrated in FIG. 6D, the work area setting unit 213 increases in length in the up-and-down direction of the work area 40C according to the eleventh pattern. At this time, the lower NFC antennas 114 located in the lower left area and a lower section in the lower central area of the NFC display 11 are not superimposed on the work areas 40B and 40C. Therefore, the NFC antennas 114 in the lower left area and a part of the lower central area of the NFC display 11 are driven, thereby enabling the NFC antennas 114 to be used for communication by NFC.

### Third Specific Example at the Time of Log-Out

Next, a third specific example at the time of log-out is described with reference to FIGS. 6E and 6F. This specific example is the same as the specific example 2 in that the employee logging out is the employee A who logs in first, but a position and a shape of the already set work areas are different.

As illustrated in FIG. 6E, it is first assumed that the work areas 40A to 40C of the respective employees A to C logging in to the information processing device 1 are already set on the NFC display 11. It is assumed here that the employee A logs out of the information processing device 1 prior to the employees B and C and the work area 40A is deleted.

In this case, the work area setting unit 213 reads, from the storage unit 22, a work area setting pattern (twelfth pattern) corresponding to “a case where an employee card having positional information as a lower left area and an employee card having positional information as a lower right area are present”, “a case where work area information about the employee card having the positional information as the lower left area is the horizontal type”, and “a case where work area information about the employee card having the positional information as the lower right area is the horizontal type”.

Then, as illustrated in FIG. 6F, the work area setting unit 213 expands the work area 40B in the left-and-right direction, reduces the work area 40C in the left-and-right direction, and expands the work area 40C in the up-and-down direction according to the twelfth pattern.

At this time, the NFC antennas 114 located at an upper end of the NFC display 11 are not superimposed on the work areas 40B and 40C. Therefore, the NFC antennas 114, which are not superimposed on the work areas 40B and 40C, are driven, thereby enabling the NFC antennas 114 to be used for communication by NFC.

Note that in FIGS. 6B, 6D, and 6F, in a case where any one of the two employees in the logged-in state logs out next, the work area of the other employee who remains in the logged-in state may be displayed at a position corresponding to the position of the card.

Note that in the above-mentioned specific examples, a basic size of the work area is 4*2 antennas for a vertical work area and 3*3 antennas for a horizontal work area with reference to the size of the NFC antenna 114. The basic size here is the size of the work area set in a case of no possibility that the work area is superimposed on another work area.

However, the basic size of each of the vertical work area and the horizontal work area is not limited to the above-described examples. For example, the basic size may be 3*2 antennas for the vertical work area and 2*2 antennas for the horizontal work area with reference to the size of the NFC antenna 114. The basic size may also be a different size and set in consideration of the entire size of the display unit 113 and viewability of the work area. It is preferable that the basic size be adjusted to a size corresponding to the number of NFC antennas 114 provided in the information processing device 1.

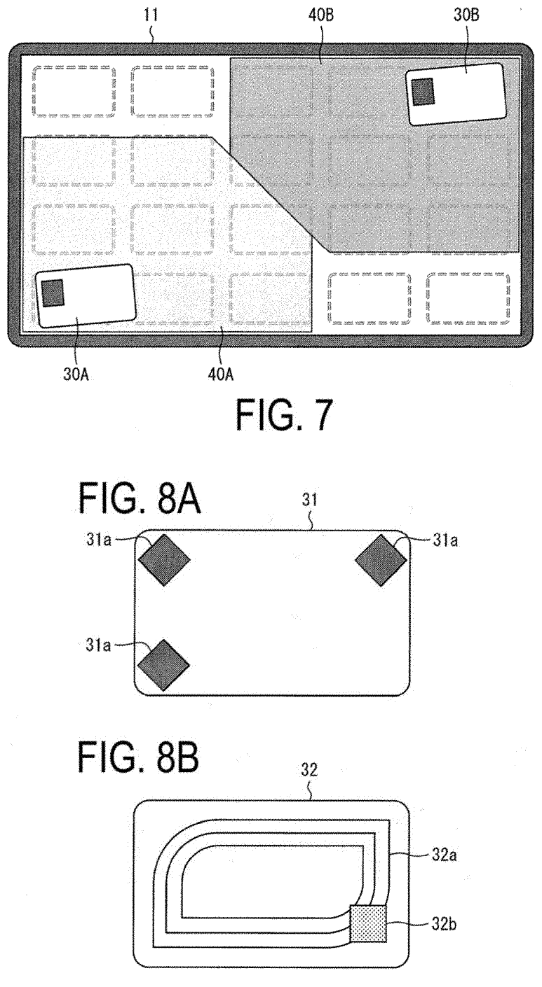

In the description above, a shape of the work area is a rectangle. However, the work area may have any other shape such as a round shape and a sector along a screen corner. FIG. 7 is a diagram illustrating an example of another shape of the work area. The work area may have a rectangular shape having a cut part (a notch shape) to avoid overlapping another work area like the work areas 40A and 40B illustrated in FIG. 7, for example.

In the description above, the work areas 40A to 40C are based on the assumption that the employees A to C are located on a lower side of the NFC display 11 illustrated in FIG. 4. However, in a case where the work area setting unit 213 can recognize a direction of an NFC terminal, the work area setting unit 213 may determine where the employees A to C are located around the NFC display from a direction of the NFC terminal and may flip the work area vertically or rotate the work area 90 degrees according to the position. Furthermore, in a case where the work area is rotated 90 degrees, settings of the size of the work area may be changed. For example, in a case where an NFC terminal having work area information set as a horizontal type (the size of 2*2 antennas) rotated 90 degrees and held over the NFC antenna 114, the work area setting unit 213 may set a vertical work area having the size of 2*3 antennas. An example of a method for recognizing a direction of an NFC terminal will be described below.

The work area setting unit 213 may control the NFC control unit 13 to stop driving some of the NFC antennas 114 according to a setting state of a layout of work areas. In this case, the application execution unit 214 may execute an app causing the display unit 113 to display a guide indicating an area in which the NFC antenna 114 is driven.

Even in a case where the number of users logging in to the information processing device 1 further increases (for example, even in a case where the number of users increases to four or more), it is preferable that the work area setting unit 213 do not set at least a part of an area on the NFC display 11 as a work area and leaves the area open to allow another user to log in. In a case where a maximum number of people (for example, 10 people) who can use the information processing device 1 at the same time is set, it is preferable that the work area setting unit 213 do not set at least a part of an area on the NFC display 11 as a work area until the number of users logging in at the same time reaches the maximum number. In other words, it is preferable that the work area setting unit 213 set an area that is not a work area in at least a part of an area on the NFC display 11 until the number of users using the information processing device 1 at the same time reaches the maximum number.

### Determination of Direction of NFC Terminal

The work area setting unit 213 may recognize a direction of an NFC terminal held over the NFC antenna 114 and adjust a direction of a work area according to the direction of the NFC terminal. In this case, the direction of the work area can be changed without making a user to perform a complicated setting operation. FIGS. 8A and 8B illustrate an example of an NFC terminal in which a direction of the NFC terminal held over an NFC antenna 114 can be recognized.

Examples of a method for recognizing a direction of an NFC terminal include a method for providing conductive patterns 31a at three places on a back surface of an NFC terminal, i.e., a surface facing the NFC display 11 like an NFC terminal 31 as illustrated in FIG. 8A, for example. In this case, in a case where the NFC terminal 31 is held over the NFC antenna 114, the touch sensor 111 detects a touch pattern corresponding to the conductive patterns 31a. An up-and-down direction and an angle of the NFC terminal 31 can be recognized based on the touch pattern provided that a relationship between a positional relationship among the conductive patterns 31a and a direction of the NFC terminal 31 is pre-stored in the storage unit 22. Note that the conductive patterns 31a may be provided at four or more places on the back surface of the NFC terminal 31.

In a case where the touch sensor built in the NFC display 11 is a capacitive sensor, a touch pattern by an antenna built in an NFC terminal is detected. Therefore, a direction of the NFC terminal 32 can be recognized by making a shape and arrangement of a built-in antenna 32a and an IC chip 32b rotationally asymmetrical like the NFC terminal 32 illustrated in FIG. 8B. Note that “rotationally symmetrical” here indicates that a rotated shape can coincide with an original shape except for when the shape is rotated n*360° (where n is a natural number). Shape recognition of an NFC terminal itself by the touch sensor 111 will be described in a second embodiment.

### Effect of Information Processing Device 1

As described above, the information processing device 1 acquires terminal information through communication from an NFC terminal of a user (employee), performs personal authentication, and sets a layout (e.g. display position, size, and direction) of a work area of the user, based on the terminal information and position information about an antenna used for communication when displaying the personal data.

Thus, even in a case where a plurality of users log in to the information processing device 1 and use the information processing device 1 at the same time, work areas are automatically set regardless of a user operation. For this reason, the information processing device 1 is easier to be used than a conventional information processing device, thereby improving operability.

The NFC control unit 13 may stop driving the NFC antenna 114 superimposed on a work area. This can reduce power consumption of the information processing device 1.

Note that the configuration in which the touch sensor 111 and the display unit 113 are superimposed on each other in the information processing device 1 is exemplified in the present embodiment, but the touch sensor 111 is not a necessary structural component in the information processing device 1. The reason is that touch information described below is not needed in a case where a work area is set based on terminal information and antenna position information. In other words, the touch sensor 111 may be excluded from the NFC display 11 in the information processing device 1.

In a case where the touch sensor 111 is excluded from the structural components of the information processing device 1, a known input device such as a mouse or a keyboard may be provided in the information processing device 1 to allow a user to perform an input operation to the information processing device.

### Second Embodiment

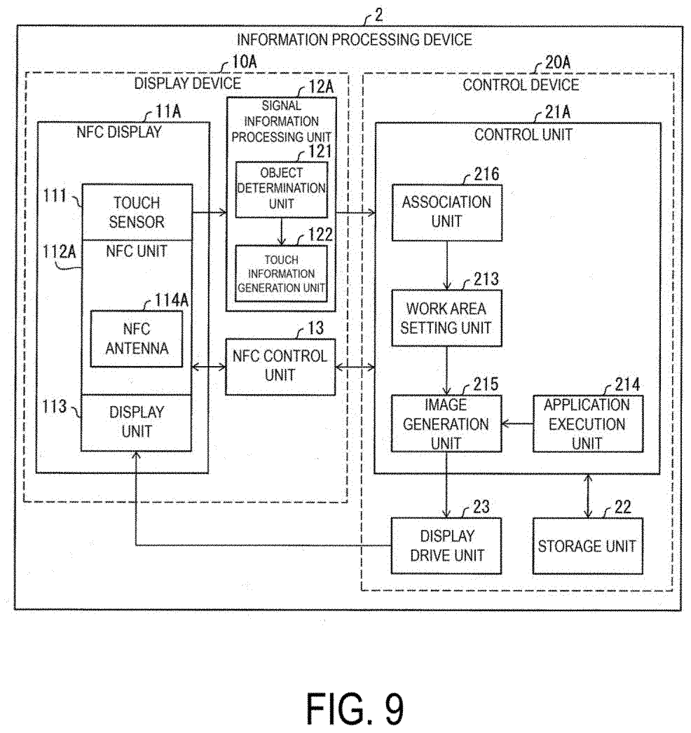

Another embodiment of the present invention will be described in the following with reference to FIGS. 9 to 16B. In the present embodiment, an information processing device 2 having a function of detecting a shape and a position of an NFC terminal by a touch sensor 111 will be described. Note that, for convenience of description, components illustrated in the above-described embodiment are designated by the same reference numerals as those having the same function, and the descriptions of these components will be omitted.

### Information Processing Device 2

First, a primary configuration of the information processing device 2 according to the present embodiment will be described with reference to FIG. 9. FIG. 9 is a block diagram illustrating an example of the primary configuration of the information processing device 2. In the information processing device 2, a display device 10A configured to display images and a control device 20A configured to control the display device 10A are integrated as one unit. The display device 10A includes an NFC display 11A and a signal information processing unit 12A instead of the NFC display 11 and the signal information processing unit 12, respectively. The control device 20A includes a control unit 21A instead of the control unit 21.

### Display Device 10A

The NFC display 11A includes an NFC unit 112A instead of the NFC unit 112. The NFC unit 112A includes one NFC antenna 114A instead of the plurality of NFC antennas 114. In other words, the information processing device 2 in the present embodiment is different from the information processing device 1 in the first embodiment in that the information processing device 2 includes only one NFC antenna.

The NFC antenna 114A is only one NFC antenna provided in a corner of the NFC unit 112A. In the following description, it is assumed that a position in which the NFC antenna 114A is provided is a lower right corner of the NFC unit 112A.

The signal information processing unit 12A processes a touch signal acquired from the touch sensor 111. In the present embodiment, the signal information processing unit 12A includes an object determination unit 121 and a touch information generation unit 122.

The object determination unit 121 determines whether an object in contact with the touch sensor 111 is a pointer such as a finger or a pen, or an NFC terminal (terminal device) having NFC functionality. Specifically, the object determination unit 121 determines whether a sensor signal indicated by the acquired signal information is a sensor signal (i.e., a “broad sensor signal” described above) generated in a wider range than a predetermined range. In a case where the sensor signal is generated in a wider range than the predetermined range, there is a high probability that the object is an NFC terminal. In contrast, in a case where the sensor signal is generated within the predetermined range, there is a high probability that the object is a pointer. The object determination unit 121 outputs the determination result to the touch information generation unit 122.

Note that the object determination unit 121 has only to be capable of determining whether the object in contact with the touch sensor 111 is a pointer or an NFC terminal; thus, the object determination unit 121 is not limited to the above-described configuration in which the object determination unit 121 determines whether the sensor signal indicated by the acquired signal information is a sensor signal generated in a wider range than the predetermined range. For example, a configuration may be employed in which the object determination unit 121 determines whether the number of acquired sensor signals is greater than a predetermined number. In such a configuration, in a case where the number is larger than the predetermined number, there is a high probability that the object is an NFC terminal. In contrast, in a case where the number is less than the predetermined number, there is a high possibility that the object is a pointer.

The touch information generation unit 122 generates touch information based on the determination result of the object determination unit 121. In a case where the acquired determination result indicates that the acquired sensor signal is not a sensor signal generated in a wider range than the predetermined range, the touch information generation unit 122 identifies the coordinates (peak coordinates) where the strongest sensor signal is generated, associates the coordinates with a touch ID for identifying touch information, and generates the touch information.

In contrast, in a case where the acquired determination result indicates that the sensor signal is generated in a wider range than the predetermined range, the touch information generation unit 122 refers to the signal information and performs shape analysis on the sensor signal.

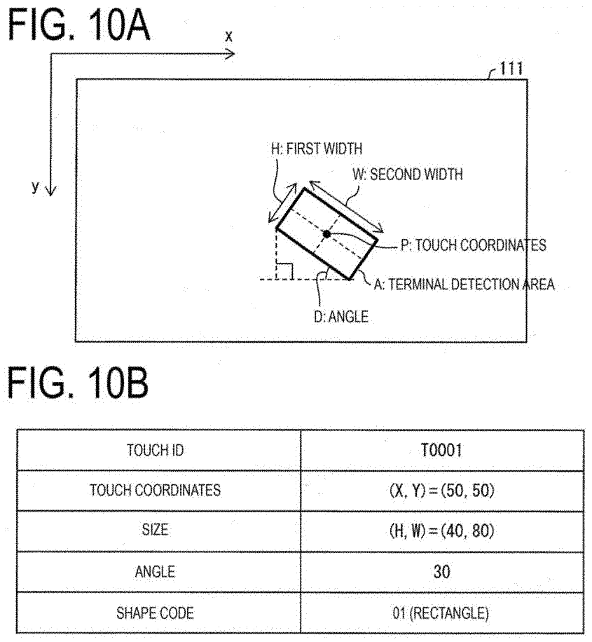

Here, the detailed description of the shape analysis and the touch information will be given with reference to FIGS. 10A and 10B. FIG. 10A is a diagram illustrating an example of each parameter of a terminal candidate area identified by shape analysis. FIG. 10B is a diagram illustrating a specific example of the touch information in a case where the object is a rectangular NFC terminal. Note that, as illustrated in FIG. 10A, the virtual XY plane may be preset on the touch sensor 111. The touch information generation unit 122 identifies the terminal candidate area from the coordinates where the sensor signal has been generated. Subsequently, the outer edges of the terminal candidate area are corrected as illustrated in FIG. 10A, so that the outer peripheral shape (outer shape) of the terminal candidate area is defined. Next, the outer peripheral shape illustrated in FIG. 10A is identified (in the case of FIG. 10A, the outer peripheral shape is identified as a rectangle), and the center coordinates (positional information, hereinafter touch coordinates), size, and inclination angle (angle information, hereinafter angle) of the rectangle are calculated. Note that the “angle” refers to an angle formed between the X axis (first axis) of the XY plane and an axis (second axis and in the example of FIGS. 10A and 10B, the long side of the rectangle) which is on the same plane as the X axis and is determined based on the outer peripheral shape of the terminal candidate area.

Note that the outer peripheral shape of the terminal candidate area may be defined with reference to the information acquired from the NFC terminal via the NFC antenna 114A, the information indicating the shapes and sizes of the NFC terminal and antenna coil.

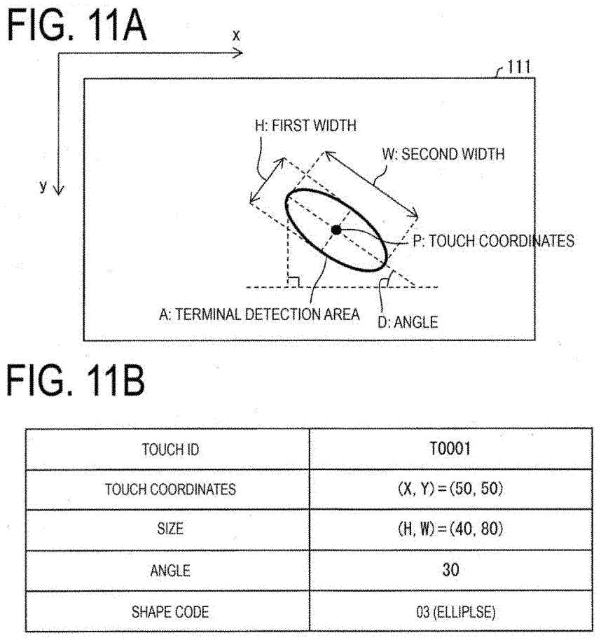

Next, the touch information generation unit 122 associates the calculated touch coordinates, size, angle, and a shape code indicating the outer peripheral shape of the terminal candidate area with the touch ID, and generates the touch information as illustrated in FIG. 10B. The touch information generation unit 122 outputs the generated touch information to an association unit 216 (terminal information acquisition unit, positional information acquisition unit, touch position information acquisition unit) described below. Here, as illustrated in FIG. 10B, the shape code is a two-digit number associated with the outer peripheral shape of the terminal candidate area. Data associated with the outer peripheral shape and the shape code is pre-stored in a storage unit 22, and, for example, as illustrated in FIG. 10B, the shape code “01” is associated with a rectangle. As illustrated in FIG. 11B described below, the shape code “03” is associated with an ellipse. Note that the association between the shape code and the shape is not limited to these examples, and for example, the shape code “02” may be associated with a circle, and “04” may be associated with a triangle. Further, combinations (associations) of shape codes and shapes, as well as the number of shape codes are not limited to the examples described above. Note that although the touch ID is composed of alphabetical characters and numeric characters and the shape code is composed of a two-digit number in FIG. 10B, this is merely an example and the present, invention is not limited to this example. In addition, although the size illustrated, in FIG. 10B is assumed to apply to an NFC terminal with an outer peripheral shape of a rectangle where H indicates the length of the short sides of the NFC terminal and W indicates the length of the long sides of the NFC terminal, the present invention is not limited to this example.

Also, the types of information included in the touch information illustrated in FIG. 10B are merely examples, and the information is not limited to these examples. For example, “status information” indicating the state of the NFC terminal placed on the NFC display 11A may also be included. Here, specific examples of the “status information” may include “touch in” indicating that the NFC terminal has come into contact with the NFC display 11A, “move” indicating that the NFC terminal is moving on the NFC display 11A, “touch out” indicating that the NFC terminal has left the NFC display 11A, and the like, but the present invention is not limited to these examples.

Here, with reference to FIGS. 11A and 11B, each parameter of a terminal candidate area and touch information in a case where an NFC terminal is not a rectangle will be described. FIG. 11A is a diagram illustrating an example of each parameter of a terminal candidate area identified by shape analysis. FIG. 11B is a diagram illustrating a specific example of the touch information in a case where the object is an elliptic NFC terminal. Here, a case of an elliptic NFC terminal will be described. Note that description of the same content as that in FIGS. 10A and 10B will be omitted here.

In the case of this example, as a result of shaping the outer peripheral shape of the terminal candidate area as illustrated in FIG. 11A, the touch information generation unit 122 identifies the shape as an ellipse. As illustrated in FIG. 11B, the touch information generation unit 122 then sets a shape code of the touch information to “03”.

Note that the size illustrated in FIG. 11B is assumed to apply to an NFC terminal with an outer peripheral shape of an ellipse where H indicates the length of the minor axis of the NFC terminal and W indicates the length of the major axis of the NFC terminal. The “angle” in the example of FIGS. 11A and 11B refers to an angle formed between the X axis (first axis) of the XY plane and an axis (second axis; the major axis of the ellipse in the example of FIGS. 11A and 11B)) which is on the same plane as the X axis and is determined based on the outer peripheral shape of the terminal candidate area.

The touch sensor 111 continuously outputs signal information to the signal information processing unit 12A while the object is in contact with the object. The touch information generation unit 122 continuously generates touch information, based on acquired signal information, and outputs the touch information to the association unit 216 described below. At this time, the touch information generation unit 122 keeps assigning the same touch ID to the generated touch information until the output of the signal information from the touch sensor 111 is interrupted.

In a case where the NFC terminal comes into contact with the touch sensor 111, the touch information generation unit 122 executes the above-described processing and generates the touch information illustrated in FIG. 10B and FIG. 11B. Subsequently, as the NFC terminal moves while in contact with the touch sensor 111, the touch information generation unit 122 continuously generates touch information based on the acquired signal information. At this time, as the NFC terminal is moving, the touch coordinates included in the touch information change.

In contrast, in a case where the NFC terminal moves while in contact with the touch sensor 111, the touch information generation unit 122 uses, as a touch ID of newly generated touch information, a touch ID of the touch information generated in a case where the NFC terminal comes into contact with the touch sensor 111. Next, the touch information generation unit 122 outputs the generated touch information to the association unit 216 described below.

### Control Device 20A

### Control Unit 21A

The control unit 21A includes the association unit 216 instead of the terminal information acquisition unit 211 and the positional information acquisition unit 212.

The association unit 216 stores the touch information acquired from the signal information processing unit 12A and the NFC terminal information acquired from the NFC control unit 13 with both the pieces of information associated with each other. Specifically, in response to acquiring touch information from the signal information processing unit 12A, the association unit 216 determines whether the touch information is touch information indicating contact of a pointer or touch information indicating contact of an NFC terminal. More specifically, the association unit 216 determines whether the touch information includes specific information of the touch information indicating contact with the NFC terminal such as a size, angle, and shape code. Note that the above-described specific information is not limited to the above examples.

Here, in a case where the association unit 216 determines that the touch information indicates contact with a pointer, that is, the touch information does not include the specific information, the association unit 216 associates the contact indicated by the touch information with contact of a pointer (finger touch), and performs the subsequent processing. Specifically, the association unit 216 outputs the touch information to an application execution unit 214.

In contrast, in a case where the touch information indicates contact with an NFC terminal, that is, the association unit 216 determines that the above-described specific information is included, the association unit 216 checks whether the NFC terminal information has been acquired from the NFC control unit 13. Here, in a case where the NFC terminal information has been acquired, the association unit 216 associates the acquired touch information with the acquired NFC terminal information to generate association data, and stores the association data in the storage unit 22. The association data includes a combination of the touch information described with reference to FIG. 10B and FIG. 11B and the NFC terminal information. The association unit 216 stores, in the storage unit 22, the association data including a combination of the touch information and the NFC terminal information.

In contrast, in a case where the NFC terminal information has not been acquired, the association unit 216 checks the touch ID included in the acquired touch information, and checks whether association data including the touch ID is present among the pieces of association data stored in the storage unit 22. In a case where such association data is present, the touch information portion included in the association data is updated to the contents of the acquired touch information. In this way, the NFC terminal information generated by communication by NFC between the NFC terminal and the information processing device 2, as well as the touch information after movement of the NFC terminal, may be stored with both the pieces of information associated with each other. This configuration enables the information processing device 2 to retain information indicating the most recent position of the NFC terminal on the NFC display 11A.

### Processing Flow Executed by Information Processing Device 2

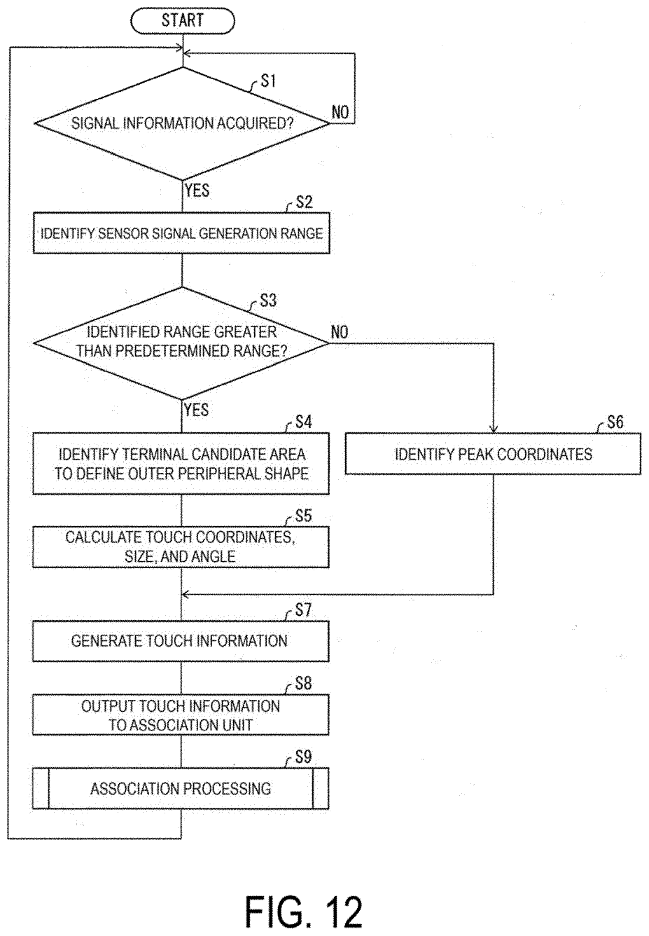

A processing flow executed by the information processing device 2 will be described with reference to FIG. 12. FIG. 12 is a flowchart illustrating an example of a processing flow executed by the information processing device 2.

First, the signal information processing unit 12A waits for signal information output from the touch sensor 111 (S1). In a case where the signal information is acquired (YES in S1), the object determination unit 121 identifies the generation range of the sensor signal with the signal information (S2), and determines whether the range is wider than a predetermined range (S3). Next, the determination result is output to the touch information generation unit 122. In a case where the generation range of the sensor signal is narrower than or equal to the predetermined range (NO in S3), the touch information generation unit 122 determines that a generation source of the sensor signal is a finger and identifies the peak coordinates in the sensor signal (S6).

In contrast, in a case where the generation range of the sensor signal is wider than the predetermined range (YES in S3), the touch information generation unit 122 determines that a generation source of the sensor signal is an NFC terminal. In this case, the touch information generation unit 122 identifies a terminal candidate area and defines the outer peripheral shape of the area. (S4). Further, the touch information generation unit 122 calculates the touch coordinates, size, and angle of the rectangle (S5).

Next, the touch information generation unit 122 generates touch information (S7), and outputs the generated touch information to the association unit 216 (S8). Subsequently, the association unit 216 executes an association process (S9). The detailed description of the association process will be given below. Upon completion of the association process, the flow returns to step S1.

### Flow of Association Process

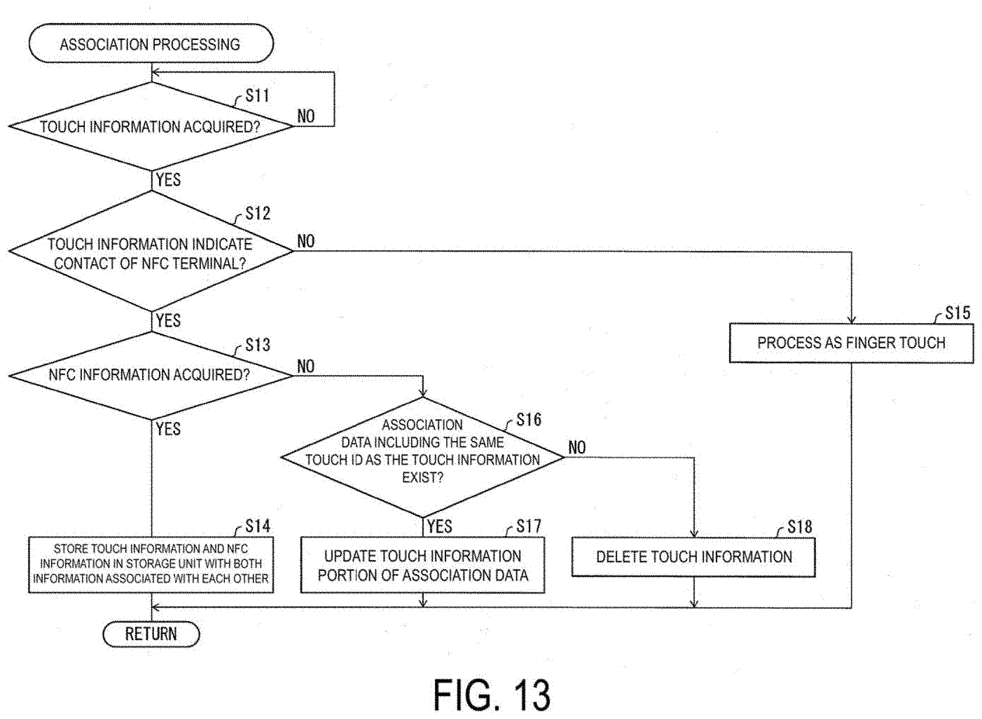

Next, a flow of the association process included in the flowchart of FIG. 12 will be described with reference to FIG. 13. FIG. 13 is a flowchart illustrating an example of a flow of the association process included in the flowchart of FIG. 12.

First, the association unit 216 is in a standby state to wait for the touch information (S11, positional information acquisition step). In a case where touch information has been acquired (YES in S11), the association unit 216 determines whether the acquired touch information is touch information indicating contact of an NFC terminal (S12), Specifically, the association unit 216 determines whether the touch information is the touch information illustrated in FIG. 10B, that is, whether the touch information, indicating contact with the NFC terminal, includes specific information such as size, angle, and shape code. In a case where touch information indicating contact of the NFC terminal is not present (NO in S12), the association unit 216 processes the contact indicated by the touch information as a finger touch (S15), and the association process is terminated.

In contrast, in a case where touch information indicating contact of the NFC terminal is present (YES in S12), the association unit 216 checks whether NFC terminal information has been acquired (S13, terminal information acquisition step). In a case where NFC information has been acquired (YES in S13), the association unit 216 stores the touch information and the NFC information with both the pieces of information associated with each other in the storage unit 22 (S14, association step), and the association process is terminated.

In contrast, in a case where NFC terminal information has not been acquired (NO in S13), the association unit 216 checks whether association data including the same touch ID as the acquired touch information is present (S16). In a case where the association data is present (YES in S16), the association unit 216 updates the touch information portion of the association data stored in the storage unit 22 (S17). In contrast, in a case where association data is not present (NO in S16), the association unit 216 deletes the acquired touch information (S18). Here, the association process is terminated.

Note that although the association unit 216 checks whether NFC terminal information has been acquired in step S13 in FIG. 13, the association unit 216 may be configured to determine whether the touch coordinates included in the touch information are coordinates corresponding to a position of the NFC antenna 114A.

### Actions of Information Processing Device 2

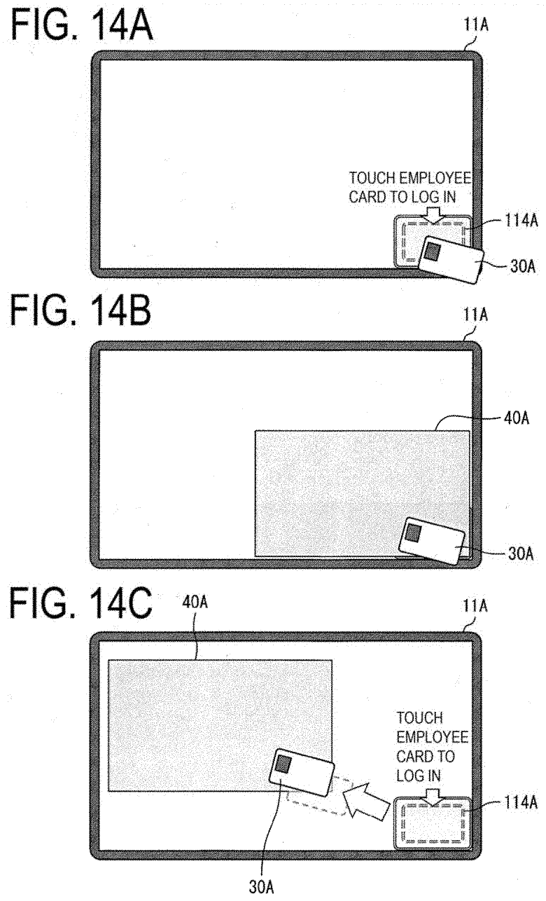

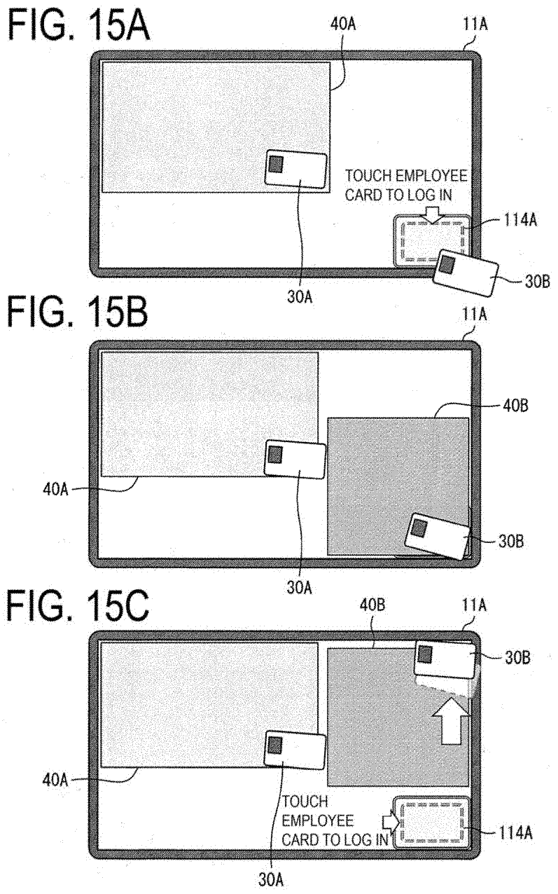

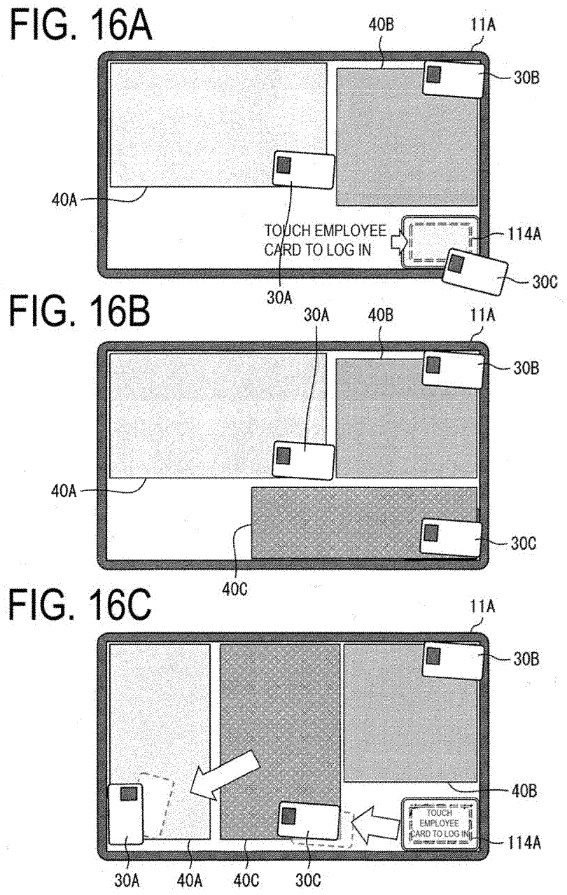

Actions of the information processing device 2 will be described with reference to FIGS. 14A to 16C. FIGS. 14A to 14C are diagrams for describing a layout of a work area in a case where a first employee logs in to the information processing device 2. FIGS. 15A to 15C are diagrams for describing a layout of a work areas) in a case where a second employee logs in to the information processing device 2. FIGS. 16A to 16C are diagrams for describing a layout of work areas in a case where a third employee logs in to the information processing device 2.

As described above, the information processing device 2 includes only one NFC antenna 114A in a corner of the NFC display 11A. An app as a shared PC executed by the application execution unit 214 allows the display unit 113 to display a guide and a message (“TOUCH EMPLOYEE CARD TO LOG IN”) indicating a position of the NFC antenna 114A and prompting an employee to hold an NFC terminal over the position.

In the following description, the information processing device 2 is a shared PC terminal usable by a plurality of employees, similarly to the specific example of the information processing device 1. An NFC terminal is an employee card. In the following description, a position of the NFC antenna 114A is assumed to be the lower right of the NFC display 11A.

Case in which First Employee (Employee A) Logs in

First, a case that a first employee (employee A) logs in to the information processing device 2 will be described with reference to FIGS. 14A to 14C. It is first assumed that, as illustrated in FIG. 14A, the employee A who previously sets work area information as the horizontal type holds his/her employee card 30A over the NFC antenna 114A to log in to the information processing device 2.

In this case, the work area setting unit reads, from the storage unit 22, a work area setting pattern (thirteenth pattern) corresponding to “a case where an employee card having positional information as an area including a position of the NFC antenna 114A is present” and “a case where work area information about the employee card held over the position of the NFC antenna 114A is the horizontal type”.

Then, as illustrated in FIG. 14B, the work area setting unit 213 sets a work area 40A of the employee A close to the NFC antenna 114A according to the thirteenth pattern. Note that in the present embodiment, “positional information” in the work area setting pattern may be indicated by any of six areas as in the first embodiment or indicated by any of further segmented areas.

Subsequently, in a case where the employee A moves the employee card 30A while the employee card 30A is in contact with the NFC display 11A, the work area setting unit 213 reads a work area setting pattern according to a shape and a position of the employee card 30A detected by the touch sensor 111 from the storage unit 22. Then, the work area setting unit 213 sets again the layout of the work area 40A according to the work area pattern. At this time, the work area 40A looks as if moving as the employee card 30A moves.

In a case where the NFC antenna 114A is not superimposed on the work area 40A due to the movement of the employee card 30A, the app in the shared PC displays the guide again in the position of the NFC antenna 114A to allow another user to log in, as illustrated in FIG. 14C. Note that the app in the shared PC may stop driving the NFC antenna 114A while the guide of the NFC antenna 114A is not displayed.

Case in which Second Employee (Employee B) Logs in

Next, a case that a second employee (employee B) logs in to the information processing device 2 in a state in which the employee A has already logged in to the information processing device 2 will be described with reference to FIGS. 15A to 15C.

As illustrated in FIG. 15A, it is first assumed that the employee B holds his/her employee card 30B over the guide position to log in to the information processing device 2. For the sake of simplicity, FIG. 15A exemplifies the same layout of the work area 40A as that of FIG. 14C.

In this case, the work area setting unit 213 reads the thirteenth pattern from the storage unit 22 similarly to the case that the employee A logs in to the information processing device 2. Then, as illustrated in FIG. 15B, the work area setting unit 213 displays a work area 40B of the employee B close to the NFC antenna 114A according to the thirteenth pattern.

At this time, the work area setting unit 213 adjusts a position and a size of the work area 40B such that the work area 40B does not coincide with the work area 40A. The work area setting unit 213 may also adjust a position and a size of the work area 40A within a range that does not greatly deviate from the position of the employee card 30A.

Subsequently, in a case where the employee B moves the employee card 30B while the employee card 30B is in contact with the NFC display 11A, the work area setting unit 213 reads a work area setting pattern according to a shape and a position of the employee card 30B detected by the touch sensor 111 as well as the shape and the position of the employee card 30A from the storage unit 22. Then, the work area setting unit 213 sets again the layout of the work areas 40A and 40B according to the work area setting pattern.

At this time, the work area setting pattern is defined such that the work area 40B does not fall outside the display area of the display unit 113. For example, as illustrated in FIG. 15B, in a case where the employee card 30B is moved to the upper right area of the NFC display 11A, the work area setting pattern is defined such that the upper right of the display unit 113 is the starting point of the work area 40B. In a case where the NFC antenna 114A is not superimposed on the work area 40B due to the movement of the employee card 30B, the app in the shared PC displays the guide again in the position of the NFC antenna 114A to allow another user to log in.

Case in which Third Employee (Employee C) Logs in

Next, a case that a third employee (employee C) logs in to the information processing device 2 in a state in which the employees A and B have already logged in to the information processing device 2 will be described with reference to FIGS. 16A to 16C.

As illustrated in FIG. 16A, it is first assumed that the employee C holds his/her employee card 30C over the NFC antenna 114A to log in to the information processing device 2. For the sake of simplicity, FIG. 16A exemplifies the same layout of the work areas 40A and 40B as that of FIG. 15C.

In this case, the work area setting unit 213 reads the thirteenth pattern similarly to the case that the employees A and B log in to the information processing device 2. Then, as illustrated in FIG. 16B, the work area setting unit 213 sets a work area 40C of the employee C close to the NFC antenna 114A according to the thirteenth pattern.

At this time, the work area setting unit 213 adjusts a position and a size of the work area 40C such that the work area 40C does not coincide with the work areas 40A or 40B. The work area setting unit 213 may also adjust positions and sizes of the work areas 40A and 40B within ranges that do not greatly deviate from the positions of the employee cards 30A and 30B, respectively.

In the NFC display 11A illustrated in FIG. 16C, the employee A moves the employee card 30A to the lower left corner of the NFC display 11A and rotates the employee card 30A 90 degrees clockwise. As a result, the work area setting unit 213 sets again the position of the work area 40A to the left side of the NFC display 11A, and sets again the direction of the work area 40A in the horizontal direction when seen from the left side of the NFC display 11A. This creates an opening area that is not set as the work areas 40A or 40B in the middle of the NFC display 11A.

Subsequently, the employee C moves the employee card 30C to the left from the position of the NFC antenna 114A, and the work area setting unit 213 then sets again the work area 40C according to the work area setting pattern in accordance with the positional information about the employee cards 30A to 30C. As a result, the work area 40C is set again to the opening area in the middle of the NFC display 11A.

Examples of a method for rotating the work area 40A in accordance with rotation of the employee card 30A include a method for setting again a direction of the work area 40A in accordance with a change in angle information (see FIG. 10B and FIG. 11B) included in touch information by the work area setting unit 213. As another example, as described with reference to FIGS. 8A and 8B in the first embodiment, the amount of rotation of the employee card 30A may be detected from a conductive pattern provided on the back side of the employee card 30A or a shape of an antenna built in the employee card 30A. Also, in this case, the work area setting unit 213 sets again a direction of the work area 40A in accordance with the amount of rotation of the employee card 30A.

In a case where the employee C moves the employee card 30C to the left from the position of the NFC antenna 114A, the work area setting unit 213 reads the work area setting pattern according to the positions of the employee cards 30A to 30C from the storage unit 22. The work area setting unit 213 then adjusts a size and an aspect ratio of the work area 40C and sets the work area 40C to the opening area in the middle of the NFC display 11A according to the work area setting pattern. At this time, the work area setting unit 213 may also adjust the size of the work areas 40A and 40B to be balanced with the work area 40C.

In this way, in order to move work areas as the employee cards move in a state in which the work areas corresponding to two or more employee cards are set, touch information and terminal information about the employee cards need to be stored in the information processing device 2 with both the pieces of information associated with each other. The association unit 216 generates and updates the association data, so that the information processing device 2 can set again work areas as the employee cards move in a state in which the work areas corresponding to two or more employee cards are set.

The work area setting unit 213 may control the size of a work area, based on size information included in touch information about an NFC terminal, that is to say, based on the size of the NFC terminal. For example, in a case of a great size of an NFC terminal, it is conceivable that a greater size of a work area is set than that in a case of a small size of an NFC terminal.

The work area setting unit 213 may control the shape of a work area based on shape code information included in touch information about an NFC terminal, that is to say, based on the shape of the NFC terminal. For example, in a case of an elliptic NFC terminal, it is conceivable that a shape of a work area is also set to an ellipse.

### Effect of Information Processing Device 2

As described above, the information processing device 2 includes the (single antenna) NFC unit 112 including only one NFC antenna 114A and has a function of detecting a shape and a position of an NFC terminal by the touch sensor 111.

The information processing device 2 detects a shape and a position of an NFC terminal by the touch sensor 111 and stores the shape and the position of the NFC terminal associated with terminal information about the NFC terminal. Thus, even in a case where a plurality of NFC terminals are held over the NFC display, a position of each of the NFC terminals cart be recognized. In a case where an NFC terminal is held over a position away from the NFC antenna 114A, a guide indicating a position of the NFC antenna 114A can also be displayed on the display unit 113.

The information processing device 2 can always recognize which position an NFC terminal acquiring terminal information is moved to and change a display position of the work area in accordance with the position. Furthermore, the information processing device 2 can change an aspect ratio of the work area or rotate the work area in accordance with a direction of the terminal.

In such an information processing device 2, personal authentication of a user is performed with terminal data acquired from an NFC terminal to set a work area of the user. Then, the work area is set again to an arbitrary place and a layout (for example, size and direction) of the work area(s) is automatically adjusted by moving the NFC terminal. Therefore, in a case where a plurality of users use the information processing device 2 at the same time, each of the users can set a work area only by moving and rotating the NFC terminal without the need for troublesome setting changes.

### Third Embodiment

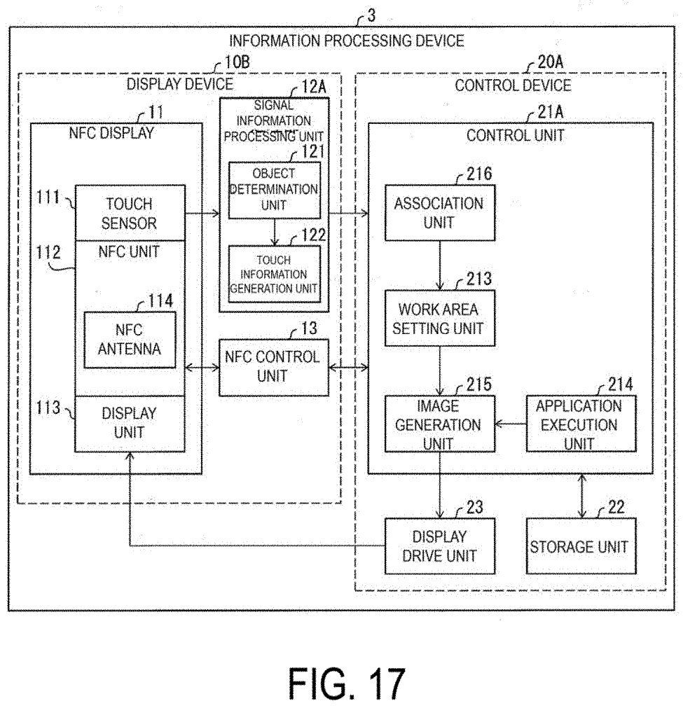

Another embodiment of the present invention will be described in the following with reference to FIG. 17 to FIG. 19B. An information processing device 3 including a plurality of NFC antennas and having a function of detecting a shape and a position of an NFC terminal by a touch sensor is described in the present embodiment.

FIG. 17 is a block diagram illustrating an example of a primary configuration of the information processing device 3. In the information processing device 3, a display device 10B configured to display images and a control device 20A configured to control the display device 10B are integrated as one unit. The display device 10B includes an NFC display 11, a signal information processing unit 12A, and an NFC control unit 13.

The information processing device 3 in the present embodiment displays a work area, based on positional information about an NFC antenna 114 over which an NFC terminal is held, terminal information about the NFC terminal, and positional information about an NFC antenna 114 over which another NFC terminal is held, or the like, similarly to the information processing device 1 in the first embodiment.

Furthermore, in a case where a user moves the NFC terminal on the NFC display 11, the information processing device 3 in the present embodiment sets again a work area, based on positional information and angle information about a moved NFC terminal detected by a touch sensor 111 and positional information and angle information about another NFC terminal, or the like, similarly to the information processing device 2 in the second embodiment.

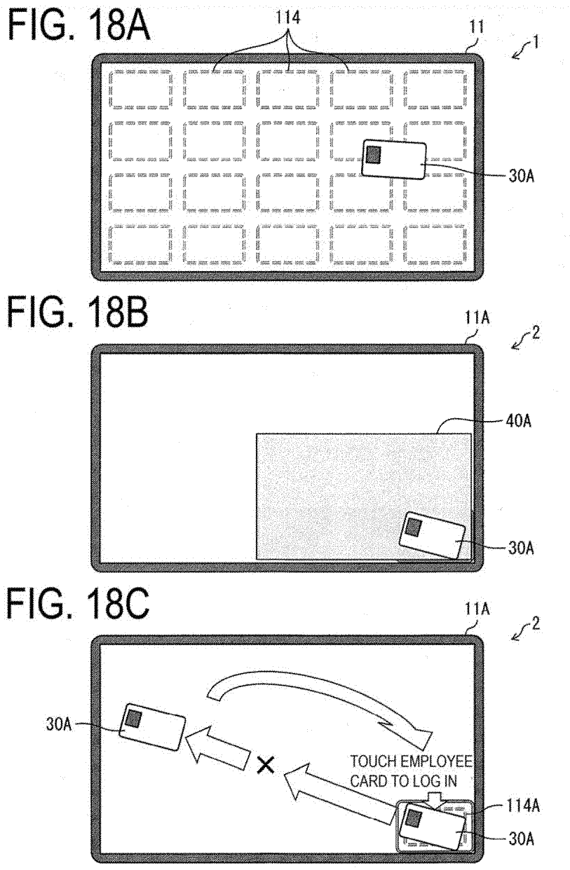

FIG. 18A is a diagram for describing a point, which can be improved, of the information processing device 1 in the first embodiment. FIGS. 18B and 18C are diagrams for describing a point, which can be improved, of the information processing device 2 described in the second embodiment.

In a case of the information processing device 1 in the first embodiment, the plurality of NFC antennas 114 are not necessarily disposed on the entire NFC display 11 without a gap. With a gap between the plurality of NFC antennas 114, there may be an area where communication by NFC is impossible, namely, a dead area.

Also, in the information processing device 1, an appropriate position for an employee card 30A to be held over can be indicated for an employee (for example, employee A) to log in, by displaying a guide of an antenna position on the NFC display 11.

However, in a case where the employee card 30A is moved while the employee logs in to the information processing device 1, the employee card 30A may enter a dead area between the plurality of NFC antennas 114 as illustrated in FIG. 18A. In this case, communication by NFC is impossible, and thus a logged-in state of the employee A cannot be maintained.

In other words, the employee A returns to a logged-out state (state before the employee A logs in) even in a case where the employee A holds the employee card 30A over the NFC display 11.

Next, it is assumed that, after the work area 40A corresponding to the employee card 30A is set as illustrated in FIG. 18B, the employee card 30A is moved on the NFC display 11A as illustrated in FIG. 18C in the information processing device 2 in the second embodiment.

In this case, a touch may be interrupted at a point X during movement. A conceivable cause of the interruption is that (i) a finger touches the NFC display 11A, (ii) the employee card 30A is moved off the NFC display 11A, or the like, during the movement of the employee card 30A.

In this case, the association between the touch information and the terminal information also becomes inappropriate, so that the employee A returns to a logged-out state (state before the employee A logs in) even in a case where the employee A holds the employee card 30A over the NFC display 11A. Thus, the employee A needs to hold the employee card 30A over the position of the NFC antenna 114 again to log in to the information processing device 2.

The information processing device 3 in the present embodiment can improve convenience of users in comparison with the information processing devices 1 and 2 by combining the configurations of the information processing device 1 and the information processing device 2.

In other words, the information processing device 3 in the present embodiment includes the plurality of NFC antennas 114 and stores touch information with terminal information with both the pieces of information associated with each other. Therefore, the information processing device 3 can store the touch information and the terminal information with both the pieces of information associated with each other in a dead area between the plurality of NFC antennas 114. In this way, even in a case where the employee card 30A enters a dead area, the logged-in state of the employee A can be maintained.

In addition, for the interruption of the touch information during movement of the employee card 30A, the plurality of NFC antennas 114 regularly reread the terminal information. In this way, the terminal information can be immediately updated even in a case where the touch information is interrupted, so that an unintentional log-out of the employee A can be prevented.

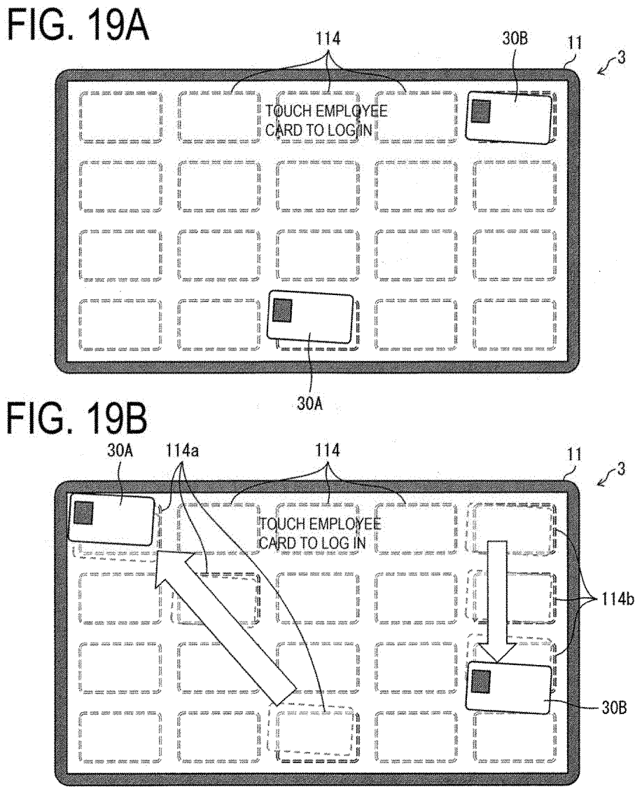

FIGS. 19A and 19B are diagrams for describing an example in a case where the employees A and B use the information processing device 3. The NFC display 11 of the information processing device 3 displays a guide indicating a position of each antenna 114 (frame surrounding each NFC antenna 114) and a message prompting a user to log in (“TOUCH EMPLOYEE CARD TO LOG IN”).

As illustrated in FIG. 19A, at the time of log-in, each of the employees A and B holds his/her employee card 30A or 30B over the position in which the guide is displayed, to log in to the information processing device 3. At this time, in a case where the position over which the employee card 30A or 30B is held is deviated from a position of the NFC antenna 114, the information processing device may detect, with the touch sensor 111, the position over which the employee card is held and display, on the NFC display 11, the guide indicating a position of the NFC antenna 114 closest to the position over which the employee card is held. After the log-in, respective work areas of the employee cards 30A and 30B are displayed on the NFC display 11 although omitted from FIGS. 19A and 19B. Subsequently, as the employee cards 30A and 30B move, the respective work areas also move as illustrated in FIG. 19B.

The information processing device 3 in the present embodiment can associate touch information about an employee card with terminal information about the employee card, similarly to the information processing device 2 in the second embodiment. Thus, in a case where an employee card is moved after log-in, an employee is not brought into a logged-out state even in a case where communication is interrupted during a passage through a dead area.

In addition, the information processing device 3 includes the plurality of NFC antennas 114, similarly to the information processing device 1 in the first embodiment. In a case where an employee card passes through an area that enables communication with the NFC antenna 114, communication is performed every time and terminal information associated with touch information is updated. For example, in FIG. 19B, the employee card 30A communicates with a plurality of NFC antennas 114a above which the employee card 30A passes during movement. Similarly, in FIG. 19B, the employee card 30B communicates with a plurality of NFC antennas 114b above which the employee card 30B passes during movement.

In this way, even in a case where a touch is interrupted and the association between the touch information and the terminal information becomes inappropriate during the movement of the employee card, a passage above the NFC antenna allows new terminal information to be associated with the touch information. Thus, the state where the employees log in to the information processing device 3 is maintained even when the interruption and the inappropriate association occur.

In a case where communication is performed again during the movement of the employee card and touch information associated with the terminal information is different from the already associated touch information, touch information is associated with the terminal information again on the assumption that the association between the terminal information and the touch information is incorrect and log-in authentication is performed again.

As described above, the information processing device 3 includes the plurality of NFC antennas 114, and can store the terminal information and the touch information with both the pieces of information associated with each other. Thus, a logged-in state is maintained even in a dead area on the NFC display 11, and an unintentional log-out due to interruption of a touch is also suppressed.

### Fourth Embodiment

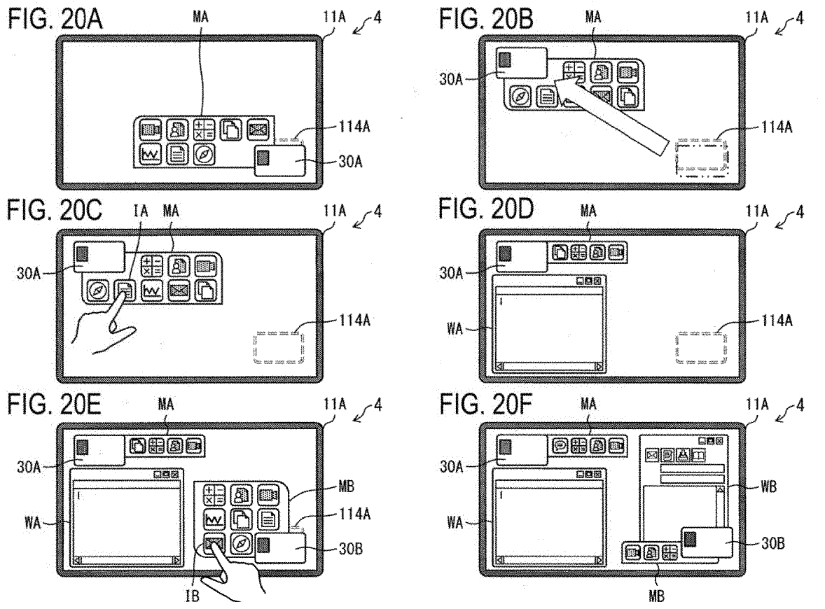

Another embodiment of the present invention will be described in the following with reference to FIGS. 20A to 20F. Here, an information processing device in the present embodiment is referred to as an information processing device 4 to distinguish the information processing device 4 from the information processing device in each of the above-described embodiments.

It can be understood that the information processing device 4 in the present embodiment has a function of adjusting a layout of a window of an app displayed in a work area added to the information processing device 2 in the second embodiment (i.e., the information processing device including one NFC antenna). Note that a method for laying out a work area(s) in the present embodiment is the same as that in the second embodiment, so that description thereof will be omitted.

However, as described below, the information processing device according to one aspect of the present invention may display a menu for causing a user to activate an app before a work area is set and may newly set a work area after the app is activated.

FIGS. 20A to 20F are diagrams for describing an example in a case where employees use the information processing device 4. Note that FIGS. 20A to 20F illustrate (i) a menu MA and a window WA described below in a work area (not illustrated) of an employee A and (ii) a menu MB and a window WB described below in a work area (not illustrated) of an employee B.

First, as illustrated in FIG. 20A, the employee A holds his/her employee card 30A over an NFC antenna 114A to log in to the information processing device 4. In this case, a display drive unit 23 displays the menu MA for the employee A on an NFC display 11A.

The menu MA is a window in which icons for activating various apps usable by the employee A are aligned and displayed. In other words, the menu MA is an image in which icons as targets of an input operation by a user to activate apps are arranged. Note that the menu MA is displayed near the employee card 30A.

Then, as illustrated in FIG. 20B, in a case where the employee A moves the employee card 30A while the employee card 30A is in contact with the NFC display 11A, a display drive unit 23 changes a position of the menu MA according to a position of the employee card 30A detected by the touch sensor 111. In this way, the menu MA moves to follow the movement of the employee card 30A.

Note that the display drive unit 23 controls the display of the menu MA according to the position of the employee card 30A such that the icons displayed in the menu MA do not overlap the employee card 30A. For example, in a case where the employee card 30A is located in the upper left area of the NFC display 11A (in a case of FIG. 20B), the menu MA is displayed in the lower right direction from the employee card 30A and the icons are arranged in the menu MA. On the other hand, in a case where the employee card 30A is located in the lower right area of the NFC display 11A (in a case of FIG. 20A), the menu MA is displayed in the upper left direction from the employee card 30A and the icons are arranged in the menu MA.

Then, as illustrated in FIG. 20C, the employee A touches one icon in the menu MA, thereby causing an application execution unit 214 to execute an app corresponding to the icon. FIG. 20C exemplifies a case that the employee A touches an icon IA to activate an app corresponding to the icon IA.

In this way, as illustrated in FIG. 20D, the window WA of the app corresponding to the icon IA is displayed by the display drive unit 23. Note that a layout of the menu MA may be set again due to the display of the window WA. This point also applies to the menu MB described below.

Here, as described above, a layout of a window of an app may be defined in advance for each type of apps. For example, in FIG. 20D, the layout of the window WA is defined in advance to be displayed in vertically long orientation.

In a case where a type of an app is a browser or mailer, a vertically long layout may be defined in advance. In a case where a type of an app is presentation software or a picture browser, a horizontally long layout may be defined in advance. In a case where a type of an app is a clock, a calculator, or the like, a layout of a window may be defined in advance such that the size of the window is relatively small. Note that a size or a ratio of a vertical length to a horizontal length of a window can be appropriately changed by a user operation.

As illustrated in FIG. 20E, the employee B holds his/her employee card 30B over the NFC antenna 114A to log in to the information processing device 4. In this way, the menu MB for the employee B is displayed. Note that FIG. 20E exemplifies a case that the employee B touches an icon IB to activate an app corresponding to the icon IB.

In this way, as illustrated in FIG. 20F, the window WB of the app corresponding to the icon IB is displayed. Herein, the menu MB and the window WB are displayed in the work area of the employee B and thus do not overlap the menu MA or the window WA displayed in the work area of the employee A. In other words, the menu MB and the window WB can be displayed at a position away from the menu MA and the window WA for the employee A.

Note that the number of apps activated by each user (employee) not limited to only one in the present embodiment. Each user can activate a plurality of apps and display respective windows of the apps aligned in his/her work area.

As described above, the information processing device 4 in the present embodiment can adjust a layout of a window of an app displayed in a work area of each user. Therefore, even in a case where a plurality of users log in to the information processing device 4 at the same time, each user can effectively use the screen of the NFC display 11A. Thus, improvement in viewability and operability for users can be achieved.

### Modification

As described above, the information processing device according to one aspect of the present invention may display a menu for causing a user to activate an app before a work area is set and may newly set a work area after the app is activated.

In the information processing device according to one aspect of the present invention, the work area setting unit may set a menu (for example, the menu MA) displayed on the NFC display as a work area at the time when the employee A logs in. This menu can be understood as a work area in an initial state (at the time of log-in). In this way, the menu can be regarded as the work area, and the work area according to the menu can be set.

As described above, the work area setting unit 213 may newly set a work area (for example, the window WS) according to an app activated by an input operation of a user on an icon in a menu (for example, according to a type of an app). In this case, for example, the menu MA and the window WS are work areas of the employee A. In this way, the work area according to the activation of the app can be set.

### Fifth Embodiment

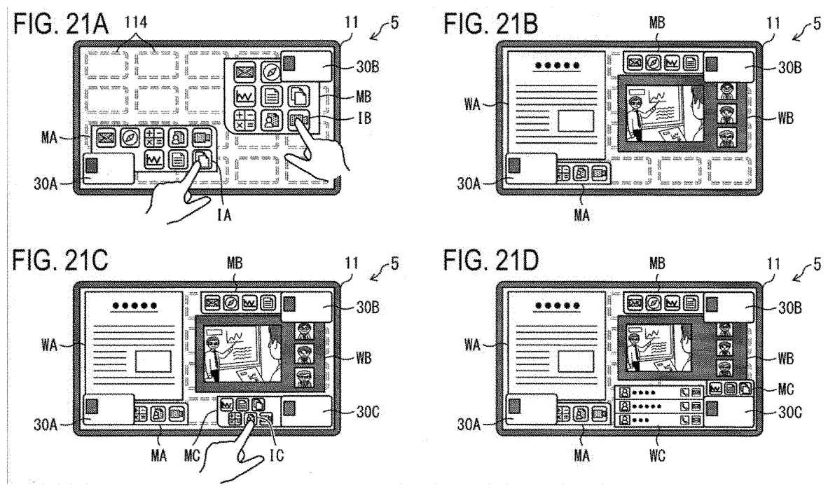

Another embodiment of the present invention will be described in the following with reference to FIGS. 21A to 21D. Here, art information processing device in the present embodiment is referred to as an information processing device 5 to distinguish the information processing device 5 from the information processing device in each of the above-described embodiments.

It can be understood that the information processing device 5 in the present embodiment has a function of adjusting a layout of a window of an app displayed in a work area added to the information processing device 1 in the first embodiment or the information processing device 3 in the third embodiment (i.e., the information processing device including the plurality of NFC antennas). Note that a method for laying out a work area(s) in the present embodiment is the same as that in the first or third embodiment, so that description thereof will be omitted. Note that a process of detecting a position of an employee card by a touch sensor 111 (a process of acquiring touch information) is not necessary for the information processing device 5.

FIGS. 21A to 21D are diagrams for describing an example in a case where employees use the information processing device 4. Note that FIGS. 21A to 21D illustrate (i) a menu MA and a window WA in a work area (not illustrated) of an employee A, (ii) a menu MB and a window WB in a work area (not illustrated) of an employee B, and (iii) a menu MC and a window WC described below in a work area (not illustrated) of the employee B.

First, as illustrated in FIG. 21A, the employees A and B respectively hold his/her employee cards 30A and 30B over NFC antennas 114 to log in to the information processing device 4. In FIG. 21A, the employee A holds the employee card 30A over the NFC antenna 114 located at the lower left of an NFC display 11. The employee B holds the employee card 30B over the NFC antenna 114 located at the upper right of the NFC display 11.

Each of the menus MA and MB is displayed on the NFC display 11 by a display drive unit 23. Note that the display positions of the menus MA and MB are set, based on the positional information described above in the present embodiment. The employee A and the employee B respectively touch an icon IA and an icon IB to activate desired apps.

In this way, as illustrated in FIG. 21B, the windows WA and WB are displayed. In a case of FIG. 21B, an area to which an additional user can log in (area that is not set as a work area) is left at the lower left of the NFC display 11. This area may be referred to as a margin area.

Herein, the work area setting unit 213 may decide (determine) whether to permit the additional user to log in through the margin area according to the number of windows displayed on the NFC display 11 or types of apps corresponding to the windows. Note that the number of windows and types of apps used for the determination may be defined in advance.

For example, in a case where it is conceivable that the number of windows is relatively small or viewability and operability of an app do not deteriorate greatly with a window reduced in size, the work area setting unit 213 permits the additional user to log in through the margin area.

On the other hand, in a case where it is conceivable that the number of windows is relatively great or viewability and operability of an app deteriorate significantly with a window reduced in size, the work area setting unit 213 does not permit the additional user to log in through the margin area. In this way, viewability and operability for each user can be maintained.

FIG. 21C exemplifies a case that an additional user in the margin area is permitted to log in. As illustrated in FIG. 21C, the employee C (additional user) holds his/her employee card 30C over an NFC antenna 114 (not illustrated) in the margin area to log in to the information processing device 4. In this way, the menu MC for the employee C is further displayed on the NFC display 11. The employee C then touches an icon IC displayed in the menu MC to activate a desired app.

In this way, as illustrated in FIG. 21D, the window WC of the app corresponding to the icon IC touched by the user is displayed. Note that the menu MC and the window WC are displayed in the work area of the employee C and thus do not overlap (i) the menu MA and the window WA displayed in the work area of the employee A and (ii) the menu MB and the window WB displayed in the work area of the employee B.

As described above, the information processing device 5 in the present embodiment can adjust a layout of a window of an app displayed in a work area of each user, similarly to the fourth embodiment described above. Note that the information processing device 5 in the present embodiment is able not to permit an additional user to log in through a margin area, and thus the information processing device 5 is beneficial particularly in a case of a narrow work area of each user.

In each of the above-described embodiments, layout settings for causing each of a plurality of users to perform operation in an individual work area of the screen on the NFC display are described. However, the screen may be shared among a plurality of users to use the information processing device in one aspect of the present invention.

For example, one screen may be shared among a plurality of users in a case where the plurality of users participate in a videoconference. In this case, a user can leave a history of participating in the videoconference by holding a card over the information processing device to log in to the information processing device. Moreover, it is possible to notify a person or a party on the other end in the videoconference that the user participate in the videoconference.

### Modification

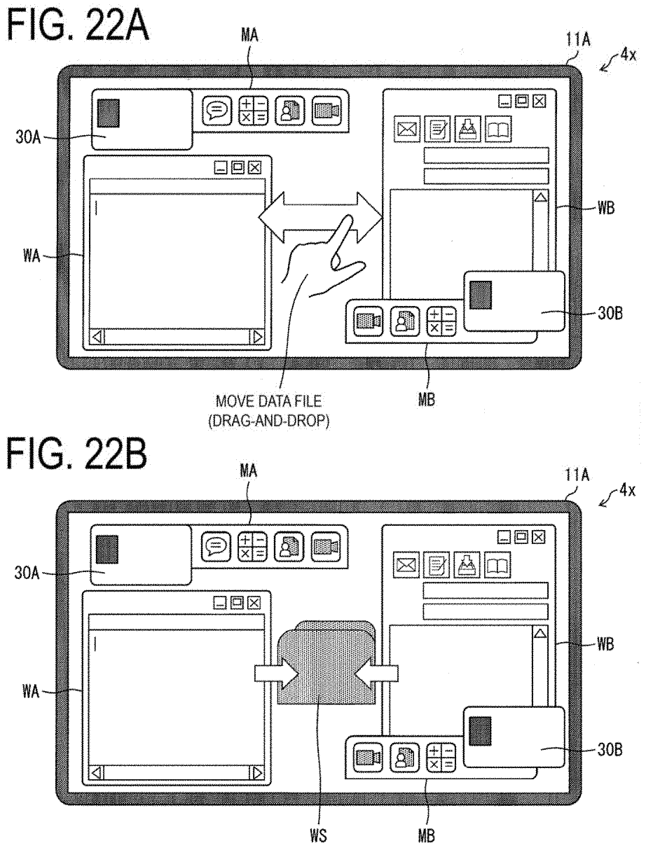

One modification of the present invention will be described in the following with reference to FIGS. 22A and 22B. Here, an information processing device in the present modification is referred to as an information processing device 4x to distinguish the information processing device 4x from the information processing device in each of the above-described embodiments.

FIGS. 22A and 22B are diagrams for describing an example in a case where employees use the information processing device 4x. For convenience of description, the information processing device 4x is exemplified as the modification of the information processing device in the fourth embodiment. However, a function of the present modification may be added to the information processing device 5 in the fifth embodiment.

In a case where a plurality of users log in to the information processing device, it is assumed to be convenient to give and receive or share data (data file) among the users.

Thus, as illustrated in FIG. 22A, a function of moving data by, for example, drag-and-drop between the window WA and the window WB may be added to the information processing device. This makes it easy to give and receive or share data among users.

As illustrated in FIG. 22B, a shared folder WS (shared work area) may be displayed between the window WA and the window WB. In other words, in the information processing device according to one aspect of the present invention, the work area setting unit 213 may set a shared folder that permits an input operation by each of a plurality of users (users A and B) between a plurality of respective work areas (windows WA and WB) for the plurality of users.

Each of the users A and B can move data to the shared folder WS by, for example, drag-and-drop. This also makes it easy to give and receive or share data among users by providing the shared folder WS. The configuration of FIG. 22B is beneficial particularly in a case of a great number of users who log in to the information processing device.

### Modification

Next, another modification of the present invention will be described. In each of the above-described embodiments, the case that a user instantly logs out by moving an employee card held over the NFC display off the NFC display is described. In this case, an image displayed in a work area of the user is instantly deleted due to log-out of the user.

However, the processing at the time of log-out in the information processing device according to one aspect of the present invention is not limited to this. For example, even in a case where an employee card is temporarily moved off the NFC display and a user temporarily logs out, an image displayed in the work area of the user may be maintained without being deleted within a predetermined time period (for example, for 10 seconds).

In other words, in the information processing device according to one aspect of the present invention, after a predetermined time period has passed since an employee card is moved off the NFC display (more specifically, the NFC unit superimposed on the NFC display), the work area setting unit 213 may cancel settings of the work area corresponding to the employee card and delete an image displayed in the work area.

In this way, a user can browse or edit data with a maintained image (window or the like) by holding an employee card over the NFC display within a predetermined time period to log in again.

Note that security needs to be guaranteed during data operation in a case where important data set in advance is opened or such an operation that saves data after editing is performed. Thus, in a case of such an operation, the information processing device may inform the user that the operation needs to be performed after the employee card is held over the NFC display again.

### Sixth Embodiment

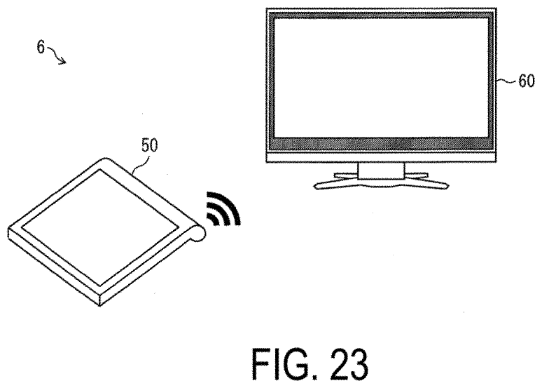

Another embodiment of the present invention will be described in the following with reference to FIG. 23. Here, an information processing device in the present embodiment is referred to as an information processing device 6 to distinguish the information processing device 6 from the information processing device in each of the above-described embodiments.

FIG. 23 is a diagram illustrating a schematic configuration of the information processing device 6. The information processing device 6 is formed of a combination of a touch pad 50 and a display device 60.

In other words, the information processing device 6 separately includes a touch sensor (touch pad 50) configured to detect an object that is in contact with or in close proximity to the touch sensor and a display unit (display device 60) having an image display function. The information processing device 6 in the present embodiment is different from the information processing device in each of the above-described embodiments in this point. Note that, in the information processing device 6, an antenna(s) is superimposed on the touch pad 50.

The touch pad 50 is configured capable of communicating with the display device 60, and transmits touch information and terminal information to the display device 60. A communication method between the touch pad 50 and the display device 60 may be based on a wired fashion illustrated in FIG. 23 or a wireless fashion. In this way, the display device 60 displays an image reflecting the touch information and the NFC terminal information, for example, a work area of a user holding an NFC terminal over the touch pad 50 and a pointer indicating a touch position of the user in the work area.

In this manner, the information processing device according to one aspect of the present invention may be formed of a combination of the touch pad 50 and the display device 60 provided separately instead of the NFC display 11 including the touch sensor and the display unit integrated as one unit.

### Implementation Example by Software

The control blocks (in particular, control units 21 and 21A) of the information processing devices 1 to 6 and 4x may be implemented by a logic circuit (hardware) formed in an integrated circuit (IC chip) and the like, or may be implemented by software using a central processing unit (CPU).

In the latter configuration, the information processing devices 1 to 4 each include a CPU for executing instructions of a program which is software for implementing each function, a read only memory (ROM) or a storage device (each of these is referred to as a “recording medium”) in which the program and various types of data are recorded in a computer-readable (or CPU-readable) manner, a random access memory (RAM) in which the program is loaded, and the like. Then, the computer (or CPU) reads the program from the recording medium and executes the program to achieve the object of the present invention. As the recording medium, a “non-transitory tangible medium”, such as a tape, a disk, a card, a semiconductor memory, and a programmable logic circuit may be used. Further, the program may be supplied to the computer via any transmission medium (a communication network, a broadcast wave, or the like) able to transmit the program. Note that one aspect of the present invention may be implemented in a form of data signal embedded in a carrier wave, which is embodied by electronic transmission of the program.

### Supplement

An information processing device (1) according to aspect 1 of the present invention includes: a display device (for example, display unit 113 or display device 60) including a screen configured to display a work area; a communication unit (NFC unit 112) superimposed on the screen and configured to perform near field communication; a terminal information acquisition unit (211) configured to acquire terminal information about each of a plurality of terminal devices held over the communication unit from the terminal device via the communication unit; a positional information acquisition unit (212) configured to acquire positional information including information about a position of an antenna (NFC antenna 114) used for acquiring the terminal information among a plurality of antennas provided in the communication unit; and a work area setting unit (213) configured to set a plurality of respective work areas for the plurality of terminal devices on the screen, based on the terminal information and the positional information.

According to the configuration above, the communication unit that is superimposed on the screen of the display device and includes the plurality of antennas performs near field communication with the terminal device. The terminal information acquisition unit acquires the terminal information from the terminal device via the communication unit. The positional information acquisition unit acquires the position of the antenna used for acquiring the terminal information as the positional information. The work area setting unit sets the plurality of respective work areas for the plurality of terminal devices on the screen of the display device, based on the terminal information and the positional information. Therefore, the size of the work area on the screen and the like can be automatically adjusted.

Preferably, an information processing device (3) according to aspect 2 of the present invention corresponds to the information processing device in aspect 1, in which the information processing device (3) further includes: a touch sensor (111) with a detection surface associated with the screen and is configured to detect an object that is in contact with or in close proximity to the detection surface; and a touch position information acquisition unit (association unit 216) configured to acquire touch information including information about a position of each of the plurality of terminal devices that is in contact with or in close proximity to the touch sensor. Preferably, the screen is superimposed on the touch sensor, and the work area setting unit sets the plurality of work areas, further based on the touch information.

According to the configuration above, the work area setting unit sets the plurality of work areas, further based on the touch information. In this way, the size of the work area on the screen and the like can be automatically adjusted by using both the positional information acquired from the antenna and the touch information acquired from the touch sensor. Thus, convenience of users can be further improved.

An information processing device (2) according to aspect 3 of the present invention is an information processing device connected and capable of communicating with a display device (for example, display unit 113 or display device 60) including a screen configured to display a work area. The information processing device includes: a touch sensor with a detection surface associated with the screen and is configured to detect an object that is in contact with or in close proximity to the detection surface; a communication unit (for example, NFC unit 112A or NFC unit 112) that is superimposed on the touch sensor and includes one antenna (for example, NFC antenna 114A or NFC antenna 114) configured to perform near field communication; a terminal information acquisition unit (association unit 216) configured to acquire terminal information about each of a plurality of terminal devices held over the communication unit from the terminal device via the communication unit; a positional information acquisition unit (association unit 216) configured to acquire touch information including information about a position of each of the plurality of terminal devices that is in contact with or in close proximity to the touch sensor; and a work area setting unit configured to set a plurality of respective work areas for the plurality of terminal devices on the screen, based on the touch information and the terminal information.

According to the configuration above, the communication unit that is superimposed on the touch sensor and includes the plurality of antennas performs near field communication with the terminal device. The terminal information acquisition unit acquires the terminal information from the terminal device via the communication unit. The positional information acquisition unit acquires the touch information including the information about the position of the terminal device that is in contact with or in close proximity to the touch sensor. The work area setting unit sets the plurality of respective work areas for the plurality of terminal devices on the screen of the display device, based on the terminal information and the touch information. Therefore, the size of the work area on the screen and the like can be automatically adjusted.

Preferably, an information processing device according to aspect 4 of the present invention corresponding to the information processing device in aspect 3 further includes a display unit (113) having a function of the display device.

According to the configuration above, operability of the information processing device for a user is improved.

Preferably, an information processing device according to aspect 5 of the present invention corresponds to the information processing device in the aspect 4, in which the display unit is superimposed on the touch sensor.

According to the configuration above, the work area can be displayed on the display unit superimposed on the touch sensor, thereby further improving operability of the information processing device for a user.

Preferably, an information processing device according to aspect 6 of the present invention corresponds to the information processing device in any one of aspects 2 to 5, in which the work area setting unit detects an angle of the terminal device with respect to the touch sensor and sets a direction of the work area on the screen, based on the angle.

According to the configuration above, the direction of the work area can be set based on the direction of the terminal device, so that the direction of the work area on the screen can be changed without making a user to perform a complicated setting operation.

Preferably, an information processing device according to aspect 7 of the present invention corresponding to the information processing device in any one of aspects 1 to 6 further includes a communication control unit (NFC control unit 13) configured to control drive of the antenna provided in the communication unit, and the communication control unit stops driving the antenna superimposed on the work area.

According to the configuration above, the communication control unit stops driving the antenna superimposed on the work area. Thus, power consumption of the information processing device can be reduced.

Preferably, an information processing device according to aspect 8 of the present invention corresponds to the information processing device in any one of aspects 1 to 7, in which a maximum number of people who can use the information processing device at the same time is set, and the work area setting unit sets an area that is not the work area in at least part of the screen until the number of people using the information processing device at the same time reaches the maximum number.

According to the configuration above, a state where a user can log in to the information processing device is maintained until the number of people using the information processing device at the same time reaches the maximum number.

Preferably, an information processing device according to aspect 9 of the present invention corresponds to the information processing device in any one of aspects 1 to 8, in which a menu (for example, menu MA) in which icons as targets of an input operation by a user to activate applications are arranged is displayed in the screen, and the work area setting unit sets the menu as the work area.

According to the configuration above, the menu can be regarded as the work area, and the work area according to the menu can thus be set.

Preferably, an information processing device according to aspect 10 of the present invention corresponds to the information processing device in aspect 9, in which the work area setting unit newly sets the work area according to an application activated by the input operation on each of the icons.

According to the configuration above, the work area according to activation of the application can be set.

Preferably, an information processing device according to aspect 11 of the present invention corresponds to the information processing device in any one of aspects 1 to 10, in which the work area setting unit sets a shared work area (shared folder WS) that permits an input operation by each of a plurality of users between the plurality of work areas corresponding to the plurality of users.

According to the configuration above, it is easy for users to give and receive or share data.

Preferably, an information processing device according to aspect 12 of the present invention corresponds to the information processing device in any one of aspects 1 to 11, in which after a predetermined time period has passed since near field communication between the communication unit and the terminal device stops, the work area setting unit cancels settings of a work area corresponding to the terminal device and deletes an image displayed in the work area.

According to the configuration above, even in a case where a user temporarily logs out, the work area and an image can be maintained by logging in again immediately afterward. Therefore, convenience of operation in the case that the user logs in again is improved.

A control device (20) according to aspect 13 of the present invention is a control device of an information processing device that includes a display device including a screen configured to display a work area, and a communication unit superimposed on the screen and configured to perform near field communication. The control device includes: a terminal information acquisition unit configured to acquire terminal information about each of a plurality of terminal devices held over the communication unit from the terminal device via the communication unit; a positional information acquisition unit configured to acquire positional information including information about a position of an antenna used for acquiring the terminal information among a plurality of antennas provided in the communication unit; and a work area setting unit configured to set a plurality of respective work areas for the plurality of terminal devices on the screen, based on the terminal information and the positional information.

According to the configuration above, an advantage effect similar to that of the information processing device according to aspect 1 is produced.

A control method according to aspect 14 of the present invention is a control method for controlling an information processing device that includes a display device including a screen configured to display a work area, and a communication unit superimposed on the screen and configured to perform near field communication. The control method includes: a terminal information acquisition step of acquiring terminal information about each of a plurality of terminal devices held over the communication unit from the terminal device via the communication unit; a positional information acquisition step of acquiring positional information including information about a position of an antenna used for acquiring the terminal information among a plurality of antennas provided in the communication unit; and a work area setting step of setting a plurality of respective work areas for the plurality of terminal devices on the screen based on the terminal information and the positional information.

According to the configuration above, an advantage effect similar to that of the information processing device according to aspect 1 is produced.

The information processing device according to each aspect of the present invention may be implemented by a computer. In this case, a control program for the information processing device which causes the computer to function as each unit (software module) included in the information processing device and a computer-readable recording medium storing the control program fall within the scope of the present invention.

The present invention is not limited to each of the above-described embodiments. It is possible to make various modifications within the scope of the claims. An embodiment obtained by appropriately combining technical elements each disclosed in different embodiments falls also within the technical scope of the present invention. Furthermore, technical elements disclosed in the respective embodiments may be combined to provide a new technical feature.

### CROSS-REFERENCE TO RELATED APPLICATION

This application claims the benefit of priority from Japanese Patent Application No. 2015-221581, filed on Nov. 11, 2015, the disclosure of which is incorporated herein in its entirety by reference.

### REFERENCE SIGNS LIST

1, 2, 3, 4, 4x, 5, 6 information processing device

10, 10A, 10B Display device

13 NFC control unit (communication control unit)

20, 20A Control device

50 Touch pad (touch sensor)

60 Display device (display unit)

111 Touch sensor

112, 112A NFC unit (communication unit)

113 Display unit (screen)

114, 114A NFC antenna (antenna)

211 Terminal information acquisition unit

212 Positional information acquisition unit

213 Work area setting unit

216 Association unit (terminal information acquisition unit, positional information acquisition unit, touch position information acquisition unit)

MA, MB, MC Menu

WS Shared folder (shared work area)

1-15. (canceled)

16. An information processing device comprising:
a display device including a screen configured to display a work area;
a communication unit superimposed on the screen and configured to perform near field communication;
a terminal information acquisition unit configured to acquire terminal information about each of a plurality of terminal devices held over the communication unit from the terminal device via the communication unit;
a positional information acquisition unit configured to acquire positional information including information about a position of an antenna used for acquiring the terminal information among a plurality of antennas provided in the communication unit; and
a work area setting unit configured to set a plurality of respective work areas for the plurality of terminal devices on the screen, based on the terminal information and the positional information.

17. The information processing device according to claim 16 further comprising:
a touch sensor including a detection surface associated with the screen and configured to detect an object that is in contact with or in close proximity to the detection surface; and
a touch position information acquisition unit configured to acquire touch information including information about a position of each of the plurality of terminal devices that is in contact with or in close proximity to the touch sensor,
wherein the screen is superimposed on the touch sensor, and
the work area setting unit further sets the plurality of work areas, based on the touch information.

18. The information processing device according to claim 17,
wherein the work area setting unit detects an angle of the terminal device with respect to the touch sensor and sets a direction of the work area on the screen, based on the angle.

19. The information processing device according to claim 16 further comprising a communication control unit configured to control drive of the antenna,
wherein the communication control unit ops driving the antenna superimposed on the work area.

20. The information processing device according to claim 16,
wherein a maximum number of people who can use the information processing device at the same time is set, and
the work area setting unit sets an area that is not the work area in at least part of the screen until the number of people using the information processing device at the same time reaches the maximum number.

21. The information processing device according to claim 16,
wherein a menu in which icons as targets of an input operation by a user to activate applications are arranged is displayed in the screen, and
the work area setting unit sets the menu as the work area.

22. The information processing device according to claim 21,
wherein the work area setting unit newly sets the work area according to an application activated by the input operation on each of the icons.

23. The information processing device according to claim 16,
wherein the work area setting unit sets a shared work area that permits an input operation by each of a plurality of users between the plurality of respective work areas for the plurality of users.

24. The information processing device according to claim 16,
wherein after a predetermined time period has passed since near field communication between the communication unit and the terminal device stops, the work area setting unit cancels settings of a work area corresponding to the terminal device and deletes an image displayed in the work area.

25. An information processing device connected and capable of communicating with a display device including a screen configured to display a work area, the information processing device comprising:
a touch sensor including a detection surface associated with the screen and configured to detect an object that is in contact with or in close proximity to the detection surface;
a communication unit superimposed on the touch sensor and including one antenna configured to perform near field communication;
a terminal information acquisition unit configured to acquire terminal information about each of a plurality of terminal devices held over the communication unit from the terminal device via the communication unit;
a positional information acquisition unit configured to acquire touch information including information about a position of each of the plurality of terminal devices that is in contact with or in close proximity to the touch sensor; and
a work area setting unit configured to set a plurality of respective work areas for the plurality of terminal devices on the screen, based on the touch information and the terminal information.

26. The information processing device according to claim 25 further comprising a display unit configured to function as the display device.

27. The information processing device according to claim 26,
wherein the display unit is superimposed on the touch sensor.

28. The information processing device according to claim 25,
wherein the work area setting unit detects an angle of the terminal device with respect to the touch sensor and sets a direction of the work area on the screen, based on the angle.

29. The information processing device according to claim 25 further comprising a communication control unit configured to control drive of the antenna,
wherein the communication control unit stops driving the antenna superimposed on the work area.

30. The information processing device according to claim 25,
wherein a maximum number of people who can use the information processing device at the same time is set, and
the work area setting unit sets an area that is not the work area in at least part of the screen until the number of people using the information processing device at the same time reaches the maximum number.

31. The information processing device according to claim 25,
wherein a menu in which icons as targets of an input operation by a user to activate applications are arranged is displayed in the screen, and
the work area setting unit sets the menu as the work area.

32. The information processing device according to claim 31,
wherein the work area setting unit newly sets the work area according to an application activated by the input operation on each of the icons.

33. The information processing device according to claim 25,
wherein the work area setting unit sets a shared work area that permits an input operation by each of a plurality of users between the plurality of respective work areas for the plurality of users.

34. The information processing device according to claim 25,
wherein after a predetermined time period has passed since near field communication between the communication unit and the terminal device stops, the work area setting unit cancels settings of a work area corresponding to the terminal device and deletes an image displayed in the work area.

35. A control method for controlling an information processing device that includes a display device including a screen configured to display a work area, and a communication unit superimposed on the screen and configured to perform near field communication, the control method comprising:
a terminal information acquisition step of acquiring terminal information about each of a plurality of terminal devices held over the communication unit from the terminal device via the communication unit;
a positional information acquisition step of acquiring positional information including information about a position of an antenna used for acquiring the terminal information among a plurality of antennas provided in the communication unit; and
a work area setting step of setting a plurality of respective work areas for the plurality of terminal devices on the screen, based on the terminal information and the positional information.
